(19) United States
(12) Patent Application Publication
(10) Pub. No.: US 2026/0012726 A1
(43) Pub. Date: Jan. 8, 2026

(54) EAR-CLIP EARPHONES

(71) Applicant: SHENZHEN SHOKZ CO., LTD., Shenzhen (CN)

(72) Inventors: Lei ZHANG, Shenzhen (CN); Chaojie CUI, Shenzhen (CN); Lei ZHONG, Shenzhen (CN); Weijie YUAN, Shenzhen (CN); Xiaobang WEN, Shenzhen (CN)

(73) Assignee: SHENZHEN SHOKZ CO., LTD., Shenzhen (CN)

(21) Appl. No.: 19/273,125

(22) Filed: Jul. 17, 2025

Related U.S. Application Data
(63) Continuation of application No. PCT/CN2024/076389, filed on Feb. 6, 2024.

(30) Foreign Application Priority Data
Dec. 11, 2023 (CN) 202311701969.7

(51) Int. Cl. H04R 1/28; H04R 1/10; H04R 7/12; H04R 7/18; H04R 9/06

(52) U.S. Cl. CPC H04R 1/2826; H04R 1/1008; H04R 1/105; H04R 1/1075; H04R 1/2803; H04R 7/12; H04R 7/18; H04R 9/063; H04R 2209/022; H04R 2400/11; H04R 2460/11

(57) ABSTRACT

An ear-clip earphone is provided. The ear-clip earphone comprises a sound production portion configured to be inserted into a concha cavity of a wearer when the ear-clip earphone is worn by the wearer. The sound production portion comprises a housing having an accommodating cavity; a first acoustic driver and a second acoustic driver disposed in the accommodating cavity, a first sound transmission channel being formed between a first diaphragm of the first acoustic driver and a second diaphragm of the second acoustic driver; a sound outlet hole disposed in the housing, the sound outlet hole being acoustically connected to the first sound transmission channel and exporting sound generated by the first acoustic driver and the second acoustic driver; an abutting portion, configured to abut against behind the ear of the wearer when the ear-clip earphone is worn; and an ear hook, configured to bypass an antihelix and a helix of the wearer and connect the sound production portion to the abutting portion when the ear-clip earphone is worn.

### CROSS-REFERENCE TO RELATED APPLICATIONS

The present disclosure is a Continuation of International Application No. PCT/CN2024/076389, filed on Feb. 27, 2024, which claims priority to Chinese Patent Application No. 202311701969.7, filed Dec. 11, 2023, the entire content of which is hereby incorporated by reference.

### TECHNICAL FIELD

The present disclosure relates to the field of sound production apparatus, and in particular, to an ear-clip earphone.

### BACKGROUND

With the development of acoustic output technology, acoustic devices (e.g., an earphone) have been widely used in people's daily lives, and they may be used in conjunction with electronic devices, such as cellular phones and computers, in order to facilitate auditory functions for the wearer. An era-clip earphone is a new type of earphone that is typically small enough to be used by clamping them near a helix of a wearer. When wearing the ear-clip earphone, a sound production portion of the earphone is inserted into a concha cavity, which does not block the ear canal and ensures safety in outdoor scenarios, and is more comfortable to wear than in-ear earphone. However, due to the size of the concha cavity, there are a lot of limitations on the volume of the sound production portion of the ear-clip earphone, which to a certain extent results in the lack of volume and poor sound quality of the ear-clip earphone.

Therefore, it is necessary to propose an ear-clip earphone to improve the output performance of the ear-clip earphone.

### SUMMARY

Embodiments of the present disclosure provide an ear-clip earphone comprising a sound production portion, configured to be inserted into a concha cavity of a wearer when the wearer wears the ear-clip earphone. The sound production portion comprises: a housing having an accommodating cavity, a first acoustic driver and a second acoustic driver disposed in the accommodating cavity, a first sound transmission channel being formed between a first diaphragm of the first acoustic driver and a second diaphragm of the second acoustic driver; a sound outlet hole disposed in the housing, the sound outlet hole being acoustically connected to the first sound transmission channel and exporting sound generated by the first acoustic driver and the second acoustic driver; an abutting portion, configured to abut against behind the ear of the wearer when the ear-clip earphone is worn; an ear hook, configured to bypass an antihelix and a helix of the wearer and connect the sound production portion to the abutting portion when the ear-clip earphone is worn.

In some embodiments, the ear hook has a first symmetry plane, the first diaphragm and the second diaphragm are disposed on two sides of the first symmetry plane, respectively, and the first diaphragm and the second diaphragm are symmetrical with respect to the first symmetry plane.

In some embodiments, the first symmetry plane passes through the sound outlet hole.

In some embodiments, the ear hook has a first symmetry plane, the first diaphragm and the second diaphragm are symmetrical with respect to a second symmetry plane, and the first symmetry plane and the second symmetry plane form an inclination angle of less than 45 degrees.

In some embodiments, the sound outlet hole is symmetrical with respect to a third symmetry plane, the third symmetry plane is perpendicular to an inner wall of the concha cavity, and the first symmetry plane and the third symmetry plane form an inclination angle of less than 45 degrees.

In some embodiments, the sound outlet hole is located entirely on a side of the first symmetry plane closer to an earlobe of the wearer when the ear-clip earphone is worn by the wearer.

In some embodiments, the ear hook has a first symmetry plane, the first diaphragm and the second diaphragm are symmetrical with respect to a fourth symmetry plane, and the fourth symmetry plane is perpendicular to the first symmetry plane.

In some embodiments, the sound outlet hole is located entirely on a side of the first symmetry plane closer to an earlobe of the wearer when the ear-clip earphone is worn by the wearer.

In some embodiments, a central axis of the sound outlet hole coincides with a central axis of the first sound transmission channel. A shape of a cross-section of the sound outlet hole perpendicular to the central axis of the sound outlet hole is the same as a shape of a cross-section of the first sound transmission channel perpendicular to the central axis of the first sound transmission channel, and an entrance of the sound outlet hole is aligned with an opening of the first sound transmission channel.

In some embodiments, the first sound transmission channel is a front cavity shared by the first diaphragm and the second diaphragm.

In some embodiments, the first acoustic driver comprises a first magnet and a first magnetic conductive shield disposed sequentially away from the first diaphragm, and a first frame for supporting the first diaphragm, the first magnet and the first magnetic conductive shield. The second acoustic driver comprises a second magnet and a second magnetic conductive shield disposed sequentially away from the second diaphragm, and a second frame for supporting the second diaphragm, the second magnet and the second magnetic conductive shield.

In some embodiments, a second sound transmission channel is formed between the first frame and the second frame, the first frame comprises a plurality of first air transmission holes, the second frame comprises a plurality of second air transmission holes. A side of the first diaphragm away from the first sound transmission channel is connected to the second sound transmission channel through the plurality of first air transmission holes, and a side of the second diaphragm away from the first sound transmission channel is connected to the second sound transmission channel through the plurality of second air transmission holes.

In some embodiments, the sound production portion further includes a mounting bracket, and the first acoustic driver and the second acoustic driver are mounted jointly on the mounting bracket.

In some embodiments, the mounting bracket is provided with a protrusion at a position corresponding to the sound outlet hole, and the protrusion abuts against an inner wall of the housing.

In some embodiments, the protrusion is provided with a through-hole, a first cross-section of the through-hole is flush with an end surface of the first frame, and a second cross-section of the through-hole is flush with an end surface of the second frame.

In some embodiments, the mounting bracket comprises the protrusion and an annular notch portion connected to the protrusion, and the annular notch portion has only one positioning structure. The positioning structure is configured to locate the first frame and the second frame with the mounting bracket, and the positioning structure is a combination of a positioning protrusion and a positioning groove.

In some embodiments, a maximum distance in an axial direction of a structure formed by the first acoustic driver, the second acoustic driver and the mounting bracket is a first dimension. A maximum distance in a radial direction of the structure formed by the first acoustic driver, the second acoustic driver and the mounting bracket is a second dimension. A ratio of the first dimension to the second dimension is within the range of 0.85 to 1.15.

In some embodiments, the housing is provided with a pressure relief hole acoustically connected to the second sound transmission channel.

In some embodiments, the first frame is provided with a plurality of first bonding pads at an end surface away from the first diaphragm, a minimum distance between at least a portion of the first bonding pads and the pressure relief hole is first minimum distance, a minimum distance between at least a portion of the air transmission holes and the pressure relief hole is a second minimum distance. The first minimum distance is greater than the second minimum distance. The second frame is provided with a plurality of second bonding pads on an end surface away from the second diaphragm, a minimum distance between at least a portion of the second bonding pads and the pressure relief hole is a third minimum distance, and a maximum distance between at least a portion of the second air transmission holes and the pressure relief hole is a fourth minimum distance. The third minimum distance is greater than the fourth minimum distance.

In some embodiments, the ear hook has a first symmetry plane, and the sound outlet hole, the first sound transmission channel, and the pressure relief hole are all symmetrical with respect to the first symmetry plane.

In some embodiments, the pressure relief hole and the sound outlet hole are acoustically isolated by an inner wall of the concha cavity when the ear-clip earphone is worn.

In some embodiments, the pressure relief hole comprises a first end, a second end, and a connection segment connecting the first end and the second end. The first end, the second end, and the connection segment are disposed in a length direction of the pressure relief hole, and a minimum width of the first end and the second end is greater than a maximum width of the connection segment.

In some embodiments, a first step structure and a second step structure are disposed on an inner side of the housing, the first step structure abuts against the first magnetic conductive shield or the first frame of the first acoustic driver. The second step structure abuts against the second magnetic conductive shield or the second frame of the second acoustic driver.

In some embodiments, the first step structure comprises a first resisting portion and a second resisting portion. The first resisting portion abuts against an end surface of the first magnetic conductive shield away from the first diaphragm, and the second resisting portion abuts against an outer side wall of the first magnetic conductive shield. The second step structure comprises a third resisting portion and a fourth resisting portion. The third resisting portion abuts against an end surface of the second magnetic conductive shield away from the second diaphragm, and the fourth resisting portion abuts against an outer side wall of the second magnetic conductive shield.

In some embodiments, sealant is filled between the first frame and the mounting bracket, and sealant is filled between the second frame and the mounting bracket.

In some embodiments, a resonance frequency of the first diaphragm and a resonance frequency of the second diaphragm are both less than 300 Hz, and a difference between the resonance frequency of the first diaphragm and the resonance frequency of the second diaphragm is less than 50 Hz.

In some embodiments, the first acoustic driver further includes a first coil disposed in the first frame, the first coil being disposed around a side wall of the first magnet, one end of the first coil being connected to the first diaphragm. The second acoustic driver further includes a second coil disposed in the second frame, the second coil being disposed around a side wall of the second magnet, one end of the second coil being connected to the second diaphragm. The ear hook has a first symmetry plane, the first frame is the same as the second frame, and the first frame and the second frame are symmetrical with respect to the first symmetry plane, the first magnetic shield is the same as the second magnetic shield, and the first magnetic shield and the second magnetic shield are symmetrical with respect to the first symmetry plane, and the first coil is the same as the second coil, and the first coil and the second coil are symmetrical with respect to the first symmetry plane.

In some embodiments, the housing comprises: a first rigid shell; a second rigid shell, configured to be disposed toward the concha cavity of the wearer when the ear-clip earphone is worn; a flexible body, configured to be in contact with the concha cavity of the wearer when the ear-clipping phone is worn. The first rigid shell and the second rigid shell enclose to form the accommodating cavity, and the flexible body covers an outer wall of the second rigid shell.

In some embodiments, a plane in which the outermost annulus of an end surface of the flexible body is located is a first reference plane, and the midpoint of a line connecting the center of the first diaphragm and the center of the second diaphragm is located outside the first reference plane; or a plane in which the outermost annulus of an end surface of the second rigid shell is located is a second reference plane, and the midpoint of the line connecting the center of the first diaphragm and the center of the second diaphragm is located outside the second reference plane.

In some embodiments, the ear hook has a first symmetry plane. A projection of the midpoint of the line connecting the center of the first diaphragm and the center of the second diaphragm on the first symmetry plane is a first projection point, an intersection line between the first reference plane and the first symmetry plane is a first intersection line, and a distance between the first projection point and the first intersection line is in the range of 0.4 mm˜4 mm.

In some embodiments, the sound outlet hole is disposed on the second rigid shell and the flexible body.

In some embodiments, a projection of an inner wall of the accommodating cavity on the first symmetry plane is a first projection, and a projection of the first reference plane on the first symmetry plane is a second projection. The first projection and the second projection have a first intersection and a second intersection, and a distance between the first intersection and the second intersection is an intersection distance. The first projection comprises a first arc segment and a second arc segment, and a ratio of the first arc segment to the intersection distance and a ratio of the second arc segment to the intersection distance are in a range of 1.4 to 1.7.

In some embodiments, the ear-clip earphone further includes a microphone assembly, the microphone assembly being disposed within the ear hook and forming a third sound transmission channel. A sound inlet hole is disposed on a side of the ear hook proximate to the sound production portion, the sound inlet hole being acoustically connected to the third sound transmission channel. The ear hook has a first symmetry plane, the sound inlet hole being symmetrical with respect to the first symmetry plane.

### BRIEF DESCRIPTION OF THE DRAWINGS

The present disclosure is further illustrated in terms of exemplary embodiments. These exemplary embodiments are described in detail with reference to the figures. These embodiments are not limiting, and in these embodiments, the same numbering denotes the same structure, wherein:

FIG. 1 is a schematic diagram of an exemplary wearing of an ear-clip earphone according to some embodiments of the present disclosure;

FIG. 2 is a schematic diagram of a structure of an ear-clip earphone according to some embodiments of the present disclosure;

FIG. 3 is a schematic diagram of a section of a sound production portion in a direction perpendicular to a length direction of an ear hook according to some embodiments of the present disclosure;

FIG. 4 is a schematic diagram of a cross-section of an ear-clip earphone on a first symmetry plane according to some embodiments of the present disclosure;

FIG. 5 is a schematic diagram of a section of an ear-clip earphone shown in a horizontal plane according to some embodiments of the present disclosure;

FIG. 6 is a graph of sound pressures received by a test microphone when a sound production portion or a sound production assembly is located at different positions of the test microphone according to some embodiments of the disclosure;

FIG. 7A is a schematic diagram of a location of a sound outlet hole according to some embodiments of the present disclosure;

FIG. 7B is a schematic diagram of an ear-clip earphone in a wearing state according to some embodiments of the present disclosure;

FIG. 8 is a schematic diagram of wearing states at different β-angles according to some embodiments of the present disclosure;

FIG. 9 is a schematic diagram of a cross-section of an ear-clip earphone on a first symmetry plane according to another embodiment of the present disclosure;

FIG. 10 is a schematic diagram of a cross-section of a sound production portion on a first symmetry plane according to other embodiments of the present disclosure;

FIG. 11 is a schematic diagram of a cross-section of a sound production portion on a first symmetry plane according to yet some further embodiments of the present disclosure;

FIG. 12 is a schematic diagram of cross-sections of two acoustic drivers in a plane in which an axial direction and a radial direction of a first magnetic conductive shield are located according to some embodiments of the present disclosure;

FIG. 13 is a top view of a first acoustic driver, a second acoustic driver, and a mounting bracket when connected according to some embodiments of the present disclosure;

FIG. 14 is a front view of a first acoustic driver, a second acoustic driver, and a mounting bracket when connected according to some embodiments of the present disclosure;

FIG. 15 is a schematic diagram of a structure of a first acoustic driver, a second acoustic driver, and a mounting bracket when connected according to another embodiment of this disclosure;

FIG. 16 is a schematic diagram of an assembly of a first acoustic driver, a second acoustic driver, and a mounting bracket according to some embodiments of the present disclosure;

FIG. 17 is a schematic diagram of a cross-section of a sound production portion in a plane in which an axial direction and a radial direction of a first magnetic conductive shield are located according to some embodiments of the present disclosure;

FIG. 18 is a schematic diagram of a structure of an ear-clip earphone according to some embodiments of the present disclosure;

FIG. 19 is a schematic diagram of a cross-section of a sound production portion in a plane parallel to a first symmetry plane according to some embodiments of the present disclosure.

### DETAILED DESCRIPTION

In order to more clearly illustrate the technical solutions of the embodiments of the present disclosure, the accompanying figures required to be used in the description of the embodiments are briefly described below. Obviously, the accompanying figures in the following description are only some examples or embodiments of the present disclosure, and it is possible for a person of ordinary skill in the art to apply the present disclosure to other similar scenarios based on the accompanying figures, without creative labor. Unless obviously obtained from the context or the context illustrates otherwise, the same numeral in the figures refers to the same structure or operation.

It should be understood that the terms “system”, “device”, “unit,” and/or “module” as used herein is a way to distinguish between different components, elements, parts, sections, or assemblies at different levels. However, the words may be replaced by other expressions if other words accomplish the same purpose.

As used in the disclosure and the appended claims, the singular forms “a,” “an,” and “the” include plural referents unless the content clearly dictates otherwise. Generally, the terms “including” and “comprising” suggest only the inclusion of clearly identified steps and elements, which do not constitute an exclusive list.

In the description of this specification, it is to be understood that the terms “first”, “second”, “third”, “fourth”, etc. are used only for descriptive purposes and are not to be understood as indicating or implying relative importance or implicitly specifying the number of technical features indicated. Thereby, the limitations “first”, “second”, “third”, “fourth” may expressly or implicitly include at least one such feature. In the description of the present specification, “plurality” means at least two, e.g., two, three, or the like, unless otherwise expressly and specifically limited.

In this specification, unless otherwise expressly specified or qualified, the terms “connection”, “fixing”, etc. shall be broadly construed. For example, the term “connection” may refer to a fixed connection, a detachable connection, a one-piece connection, a mechanical connection, an electrical connection, a direct connection, or an indirect connection through an intermediate medium, a connection within two elements, or an interaction between two elements, unless expressly limited otherwise. To one of ordinary skill in the art, the specific meaning of the above terms in this specification may be understood on a case-by-case basis.

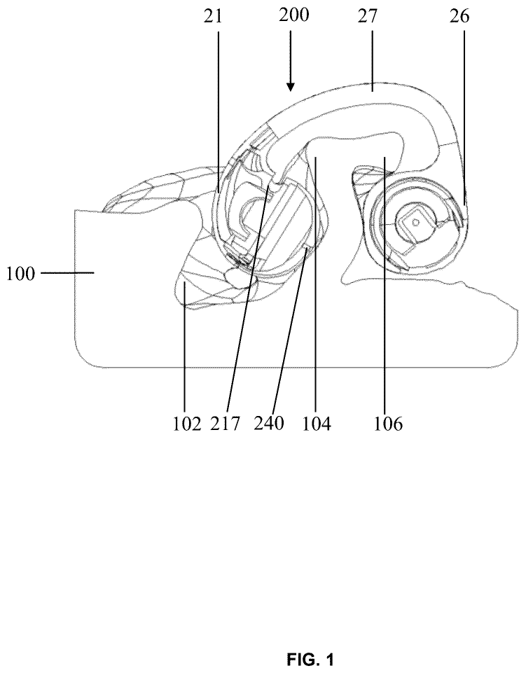

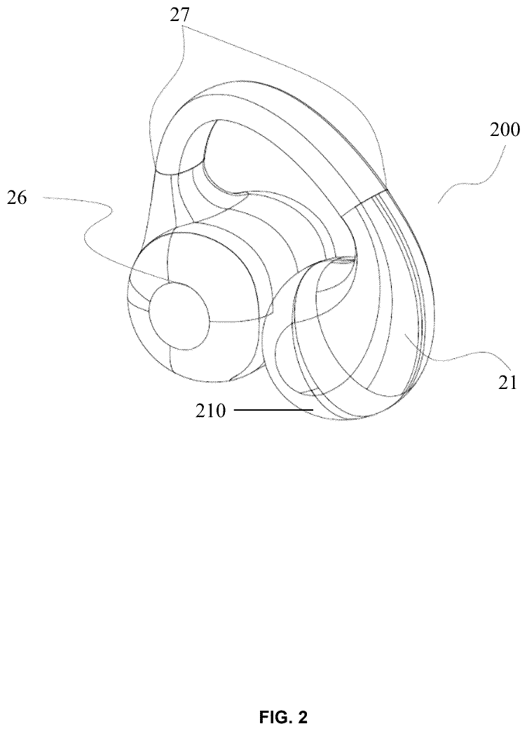

FIG. 1 is a schematic diagram of an exemplary wearing of an ear-clip earphone according to some embodiments of the present disclosure. FIG. 2 is a schematic diagram of a structure of an ear-clip earphone according to some embodiments of the present disclosure. In some embodiments, an ear-clip earphone 200 may include, but are not limited to, an air-conduction earphone, a bone air-conduction earphone, an earphone combining air-conduction and bone-conduction, etc. As shown in FIG. 1 and FIG. 2, the ear-clip earphone 200 may include a sound production portion 21 (or referred to as a sound production assembly), an abutting portion 26, and an ear hook 27 connecting the sound production portion 21 to the abutting portion 26. The ear-clip earphone 200 may be clamped to an ear 100 of a wearer by the fit of the ear hook 27, the sound production portion 21, and the abutting portion 26.

In some embodiments, when the ear-clip earphone 200 is in a wearing state, the sound production portion 21 is disposed within a concha cavity 102 of the wearer and abuts against the inner wall of the concha cavity 102. The abutting portion 26 abuts behind the ear of the wearer, e.g., against the back of the concha cavity 102. The two ends of the ear hook 27 are connected to the abutting portion 26 and the sound production portion 21, respectively, and the middle region of the two ends of the ear hook 27 is formed into an extension with a certain curvature, so that the ear hook 27 may bypass an antihelix 104 and a helix 106 of the wearer when worn. The ear hook 27 may have elasticity, as evidenced by the ear hook 27 being able to provide an elastic force to drive the sound production portion 21 to close to the abutting portion 26 when the sound production portion 21 is away from the abutting portion 26. In the wearing state, the elastic force of the ear hook 27 may be converted into a clamping force that causes the sound production portion 21 and the abutting portion 26 to be clamped on the front and back sides of the concha cavity 102, ensuring the stability of the wearing.

In some embodiments, in order to match the shape of the concha cavity 102, the shape of the sound production portion 21 needs to be similar to the shape of the concha cavity 102, for example, in the form of a sphere, a sphere-like body, or a fusiform body, etc., to make the sound production portion 21 in full contact with the inner wall of the concha cavity 102, and clamped to the front and back sides of the concha cavity 102 with the abutting portion 26. Constrained by the spatial dimension of the concha cavity 102, the size of the housing of the sound production portion 21 is small, which restricts the size of the acoustic driver housed inside the housing, resulting in a low sound production efficiency of the sound production portion 21.

On this basis, some embodiments of the present disclosure present the ear-clip earphone in which two acoustic drivers are provided inside a housing of the sound production portion, and a first sound transmission channel is formed between diaphragms of the two acoustic drivers. By providing a sound outlet hole in the housing of the sound production portion, acoustically connected to the first sound transmission channel, it is possible to export the sound generated by the two acoustic drivers at the same time, which improves the listening volume of the user. In some embodiments, by optimizing the structure of the two acoustic drivers and the arrangement of the two acoustic drivers, it is possible to make the overall structure formed by the two acoustic drivers better adapt to the internal space of the housing of the sound production portion, thereby fully utilizing the limited space of the housing of the sound production portion, further improving the sound production efficiency of the sound production portion. The ear-clip earphone proposed in the present disclosure can fully and efficiently utilize the internal space of the housing of the sound production portion when the sound production portion is extended into the concha cavity, and also improve the overall sound production efficiency of the sound production portion, which significantly improves the wearing comfort of the ear-clip earphone and sound quality.

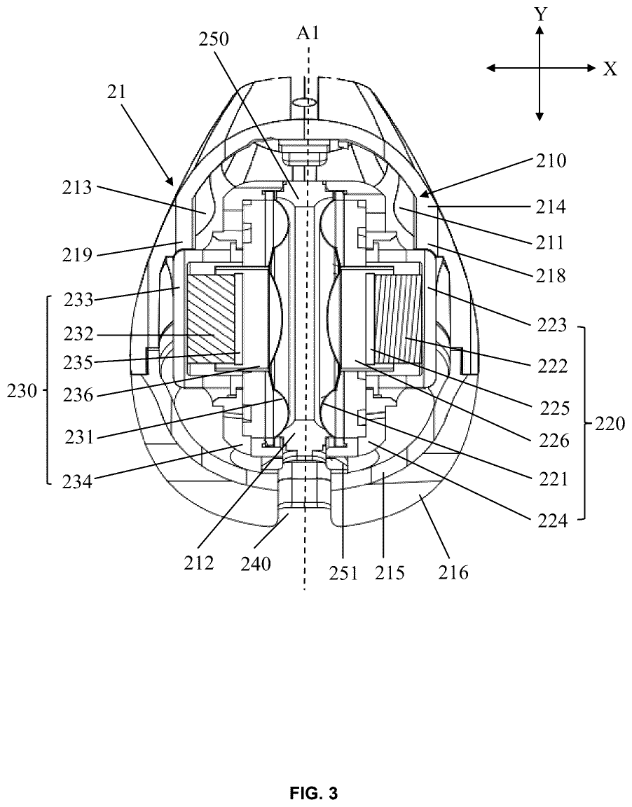

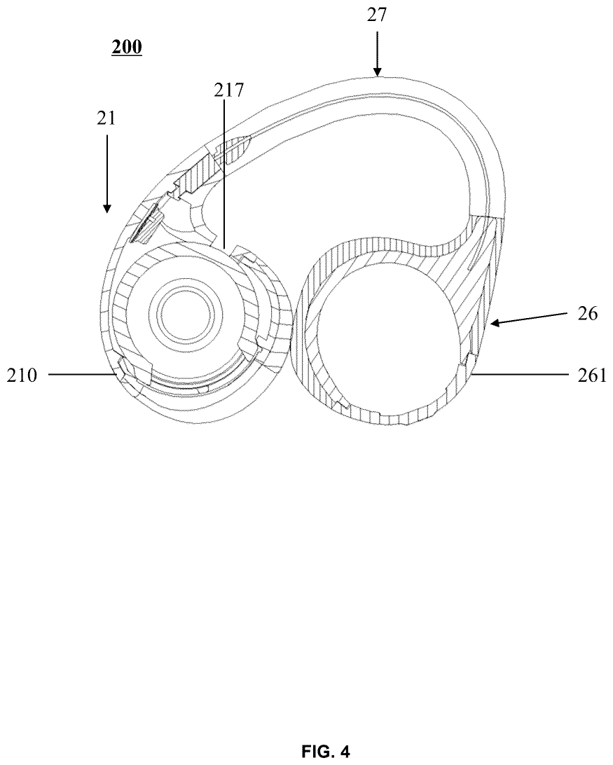

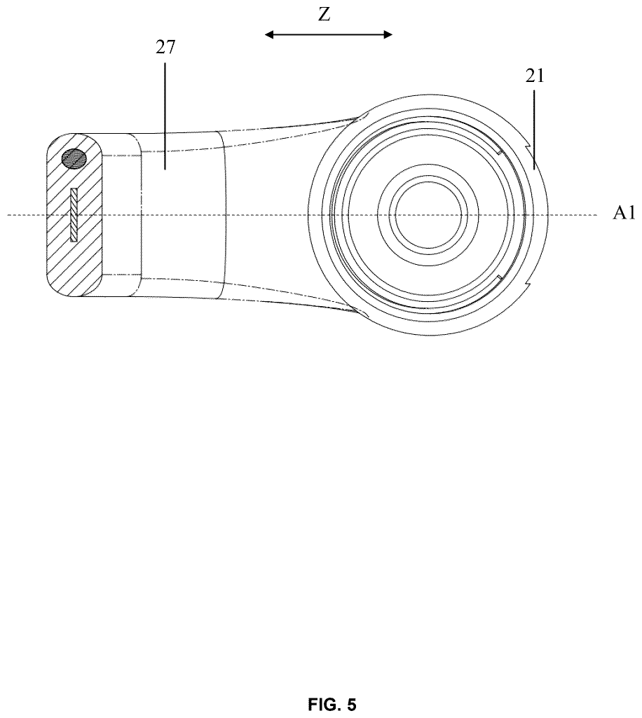

FIG. 3 is a schematic diagram of a section of a sound production portion in a direction perpendicular to a length direction of an ear hook according to some embodiments of the present disclosure. FIG. 4 is a schematic diagram of a cross-section of an ear-clip earphone on a first symmetry plane according to some embodiments of the present disclosure. FIG. 5 is a schematic diagram of a section of an ear-clip earphone shown in a horizontal plane according to some embodiments of the present disclosure. In conjunction with FIG. 1 to FIG. 5 shown, the ear hook 27 has a first symmetry plane A1, the first symmetry plane A1 being a plane that divides the ear hook 27 into two symmetrical portions along a length direction of the ear hook 27. The first symmetry plane A1 is parallel or substantially parallel to the length direction of the ear hook 27, and thus the first symmetry plane A1 may also be referred to as the ear hook length direction symmetry plane. The length direction of the ear hook 27 refers to a direction in which an end of the ear hook 27 connected to the abutting portion 26 extends toward an end of the ear hook 27 connected to the sound production portion 21, and the length direction of the ear hook 27 may be indicated by the arrow Z in FIG. 5.

In some embodiments, the ear hook 27 may include, but is not limited to, a hook structure, an elastic band, a metal wire, or a metal sheet, etc., enabling the ear-clip earphone 200 to be better secured to the wearer and preventing falling off while wearing.

In some embodiments, in conjunction with those shown in FIG. 1 to FIG. 4, the abutting portion 26 abuts against the back of the ear of the wearer to form a clamping shape in conjunction with the sound production portion 21 to clamp the ear 100. In some embodiments, the abutting portion 26 may have a second housing 261, and the abutting portion 26 is coupled to the ear hook 27 via the second housing 261. The second housing 261 may form an accommodating space. In some embodiments, the accommodating space formed by the second housing 261 may serve as a battery compartment for holding batteries and/or other components, such as circuit boards. In some embodiments, a battery may provide electrical power to the ear-clip earphone 200, e.g., the battery may be electrically coupled to the sound production portion 21 to provide electrical power to the sound production portion 21. In some embodiments, the circuit board may be electrically connected (e.g., electrically connected via wires or a flexible circuit board) to the sound production portion 21 to enable the circuit board to control the sound production of the sound production portion 21. In some embodiments, the circuit board and the battery may be both provided in the accommodating space formed by the second housing 261. In some embodiments, the circuit board and the battery may also be disposed in the accommodating space formed by the second housing 261 and a housing 210 of the sound production portion 21, respectively, and the circuit board and the battery may be electrically connected to each other via corresponding conductors, and further electrically connected to the sound production portion through the conductors. In some embodiments, the circuit board and the battery may also both be provided within the housing 210 of the sound production portion 21.

The sound production portion 21 is a sound production device of the ear-clip earphone 200. As shown in FIG. 3, the sound production portion 21 may include the housing 210, a first acoustic driver 220, a second acoustic driver 230, and a sound outlet hole 240. The housing 210 has an accommodating cavity 211. The first acoustic driver 220 and the second acoustic driver 230 are collectively disposed within the accommodating cavity 211. The sound outlet holes 240 are disposed on the housing 210. The sound outlet hole 240 is used to export sound generated by the first acoustic driver 220 and the second acoustic driver 230.

In some embodiments, the housing 210 may be integrally molded. In some embodiments, the housing 210 may include a plurality of portions. For example, the housing 210 may include a first rigid shell 214 and a second rigid shell 215. The first rigid shell 214 and the second rigid shell 215 enclose to form the housing 210 with the accommodating cavity 211. One of the two rigid shells (e.g., the second rigid shell 215) is oriented toward the concha cavity of the wearer and is in contact with the inner wall of the concha cavity. The other rigid shell is connected to the ear hook 27. In some embodiments, the housing 210 may also include a flexible body 216. An outer surface of one of the two rigid shells that is in contact with the inner wall of the concha cavity of the wearer (e.g., the second rigid shell 215) may be covered with the flexible body 216.

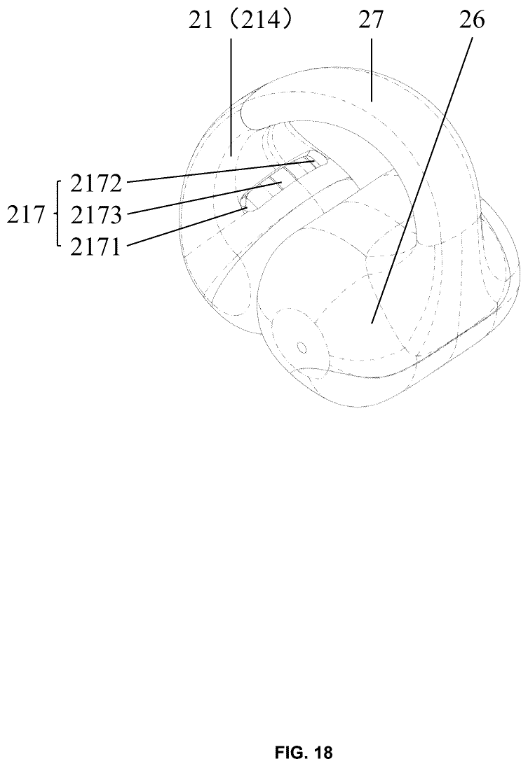

An acoustic driver refers to a device that can receive electrical signals and convert them into sound signals for output, for example, a loudspeaker, a transducer, etc. The acoustic driver may include a diaphragm and a magnetic circuit assembly. The magnetic circuit assembly is used to generate a magnetic field. In some embodiments, the magnetic circuit assembly may include a magnet, a magnetic conductive shield, a magnetic conductive plate, and a coil. The diaphragm is capable of vibrating in response to the magnetic field and the coil, and driving the air around the diaphragm to vibrate. The cavities within the housing 210 (i.e., the accommodating cavity 211) may be separated by the diaphragm into at least a front cavity and a rear cavity. The front cavity refers to an acoustic cavity formed on a side of the diaphragm away from the magnetic circuit assembly. The rear cavity refers to an acoustic cavity formed on a side of the diaphragm close to the magnetic circuit assembly. Sound generated by the side of the diaphragm away from the magnetic circuit assembly is directed out of the housing 210 through the sound outlet hole 240 connected to the front cavity. Sound generated on the side of the diaphragm facing the magnetic circuit assembly is directed out of the housing 210 through a pressure relief hole acoustically connected to the rear cavity (e.g., a pressure relief hole 217 shown in FIG. 18).

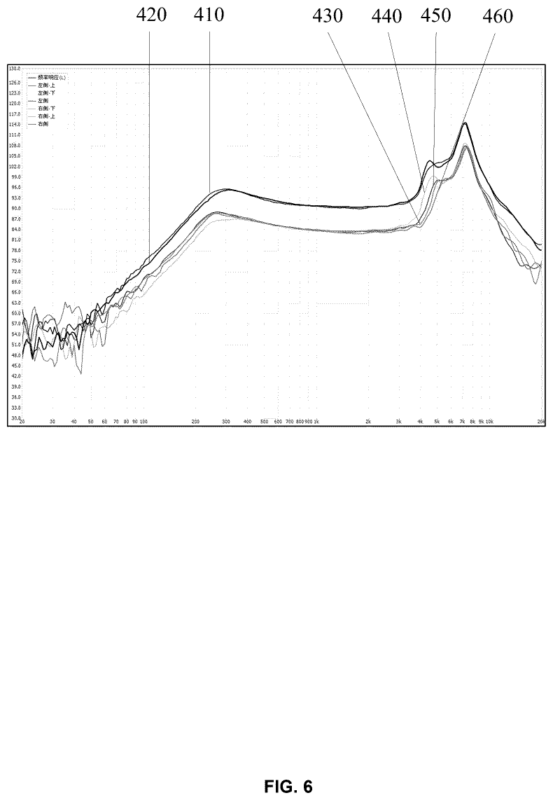

In this embodiment, by providing two acoustic drivers inside the housing 210 of the sound production portion 21, it is possible to export the sound produced by the two acoustic drivers simultaneously, which improves the listening volume of the wearer. FIG. 6 is a graph of sound pressures received by a test microphone when a sound production portion (e.g., the sound production portion 21 of FIG. 1) and a sound production assembly are located at different positions relative to the test microphone. The test microphone is capable of receiving sound signals from the outside world. As shown in FIG. 6, the graph shows a sound pressure curve 410 received by the test microphone when the sound production portion is located to the left of the test microphone, a sound pressure curve 420 received by the test microphone when the sound production portion is located to the right of the test microphone, and a sound pressure curve 430 received by the test microphone when the sound production assembly is located at the upper left of the test microphone, a sound pressure curve 440 received by the test microphone when the sound production assembly is located at the lower left of the test microphone, a sound pressure curve 450 received by the test microphone when the sound production assembly is located at the upper right of the test microphone, and a sound pressure curve 460 received by the test microphone when the sound production assembly is located at the lower right of the test microphone. Wherein, the upper and lower sides in this embodiment correspond to opposite sides of the test microphone, and the left side and the right side correspond to opposite sides of the test microphone, and a direction of the upper side pointing downward is different from a direction of the left side pointing to the right side. The sound pressure curve 410 and the sound pressure curve 420 correspond to a sound production portion having a dual-diaphragm structure (e.g., the sound production portion 21 in FIG. 1) in the embodiments of this specification, and the two diaphragms are connected in parallel at the same voltage. The sound pressure curves 430˜460 correspond to a sound production assembly with a single diaphragm structure. Assuming that the sound pressure at a sound outlet hole of the sound production assembly with the single diaphragm is P, the sound pressure at a sound outlet hole of the sound production portion with the dual-diaphragm having the same voltage and being connected in parallel is 2P1 according to the following Equation (1) of sound pressure level:

$$SPL = 20 * log 10 ( P / Pref ) , \qquad ( 1 )$$

where Pref denotes a reference sound pressure, a difference between a sound pressure level of the sound production assembly with the single diaphragm structure and a sound pressure level of the sound production portion with the dual-diaphragm structure is determined according to the following Equation (2):

$$Δ = 20 * log 10 ( 2 P / P ) = 20 * log 10 ( 2 ) \approx 6 dB , \qquad ( 2 )$$

That is to say, by setting up the dual-diaphragm structure, the sound pressure level of the sound production portion may be effectively increased, thus increasing the listening volume of the wearer.

As shown in FIG. 3, the first acoustic driver 220 may include a first diaphragm 221 and a first magnetic circuit assembly (e.g., a first magnetic conductive plate 225, a first magnet 222, and a first magnetic conductive shield 223, in order, away from the first diaphragm 221) disposed on one side of a vibration direction of the first diaphragm 221. The second acoustic driver 230 may include a second diaphragm 231 and a second magnetic circuit assembly (e.g., a second magnetic conductive plate 235, a second magnet 232, and a second magnetic conductive shield 233, in order, away from the second diaphragm 231) disposed on one side of a vibration direction of the second diaphragm 231. A first sound transmission channel 212 is formed between the first diaphragm 221 and the second diaphragm 231. The first sound transmission channel 212 and the first magnetic circuit assembly are disposed on two sides of the vibration direction of the first diaphragm 221, respectively, and the first sound transmission channel 212 corresponds to the front cavity of the first acoustic driver 220. The second sound transmission channel 213 and the second magnetic circuit assembly are disposed on two sides of the vibration direction of the second diaphragm 231, respectively, and the first sound transmission channel 212 is also equivalent to the front cavity of the second acoustic driver 230. The first sound transmission channel 212 serves as the front cavity of both the first acoustic driver 220 and the second acoustic driver 230, and thus, the first sound transmission channel 212 is a front cavity shared by the first acoustic driver 220 and the second acoustic driver 230. The vibration direction of the diaphragm may be a direction perpendicular to a plane in which the diaphragm is located, which may be indicated by the arrow X in FIG. 3.

In the case where the first acoustic driver 220 and the second acoustic driver 230 share a front cavity, sound waves in the front cavity of the two acoustic drivers may be exported out of the housing 210 through the same sound outlet hole 240, thereby simplifying the overall structure of the sound production portion 21, and reducing the manufacturing cost of the sound production portion 21. In other words, a count of openings in the housing 210 may be reduced by setting the first acoustic driver 220 and the second acoustic driver 230 to share the common front cavity. In addition, the dual-diaphragm structure working in concert has a greater effect on the change in sound pressure in the first sound transmission channel 212, and an area of the cross-section of the sound outlet hole 240 is unchanged, the two acoustic drivers working together can increase the sound volume exported from the sound outlet hole 240, thereby improving the sound effect.

In some embodiments, the front cavity of the first acoustic driver 220 and the front cavity of the second acoustic driver 230 may be independent of each other and acoustically connected to separate sound outlet holes, respectively.

In some embodiments, the rear cavity of the first acoustic driver 220 and the rear cavity of the second acoustic driver 230 may be independent of each other and acoustically connected to different pressure relief holes. For example, there may be two pressure relief holes 217 shown in FIG. 18, the two pressure relief holes 217 are connected to the rear cavity of the first acoustic driver 220 and the rear cavity of the second acoustic driver 230, respectively. In some embodiments, the rear cavity of the first acoustic driver 220 and the rear cavity of the second acoustic driver 230 may be connected to each other and export sound outwardly through the same pressure relief hole (e.g., the pressure relief hole 217 in FIG. 18). That is, the first acoustic driver 220 and the second acoustic driver 230 share a rear cavity.

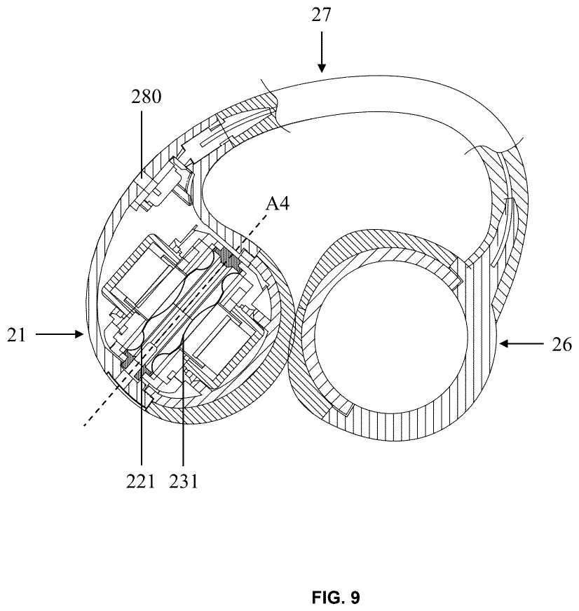

In some embodiments, shown in conjunction with FIG. 1 to FIG. 5, the ear-clip earphone 200 may further include a microphone assembly (not embodied in the figures) configured to convert the received acoustic signal into an electrical signal. In some embodiments, differentiated by the principle of transduction, the microphone assembly may include a condenser microphone, a piezoelectric microphone, a piezoresistive microphone, or the like. In some embodiments, differentiated by the manner in which sound is captured, the microphone assembly may include a gas-conducting (i.e., air-conducting) microphone or a combination of a gas-conducting and bone-conducting microphone. In some embodiments, the microphone assembly may be provided within the ear hook 27, and the microphone assembly may form a third sound transmission channel (not embodied in the figures). The ear hook 27 is provided with a sound inlet hole (e.g., a sound inlet hole 280 in FIG. 9) on the side of the ear hook 27 proximate to the sound production portion 21, and the sound inlet hole is acoustically coupled to the third sound transmission channel. The sound inlet hole may be symmetrical with respect to the first symmetry plane A1. In this embodiment, sound signals (e.g., signals generated when the wearer speaks) may be transmitted through the sound inlet hole into the third sound transmission channel, and be received by the microphone assembly through the third sound transmission channel, and then be processed by the microphone assembly to obtain the corresponding electrical signals. By making the sound inlet hole symmetrically provided with respect to the first symmetry plane A1, it is possible to make the ear-clip earphone 200, whether worn in the wearer's left ear or the right ear, have no greater influence on the effect of the microphone assembly in receiving the sound signal.

In some embodiments, the first diaphragm 221 and the second diaphragm 231 may be the same or similar. As an example only, it may be learned in conjunction with FIG. 3 to FIG. 6 that the sound pressure curve 410 and the sound pressure curve 420 corresponding to the sound production portion with the dual-diaphragm structure generate a peak at a frequency between 200 Hz and 300 Hz, which is the frequency at which the corresponding sound production portion generates a resonance peak. That is, the resonance frequency of the first diaphragm 221 and the resonance frequency of the second diaphragm 231 are lower than 300 Hz, and the difference between the resonance frequency of the first diaphragm 221 and the resonance frequency of the second diaphragm 231 is less than 50 Hz. Resonance frequency is the first resonance peak that occurs in order of frequency from low to high when an electroacoustic sweep test is performed on the sound production portion (e.g., a structure consisting of the acoustic driver, the housing, a cavity inside the housing, etc.). The position at which this resonance peak appears corresponds to the position at which the impedance curve of the sound production portion suddenly increases. The resonance frequency of the diaphragm is resonance frequency presented after the diaphragm has been assembled into the acoustic driver. The frequencies of the resonance peaks of the two diaphragms of the sound production portion 21 in the embodiment of the present disclosure are both lower than 300 Hz, e.g., both of the two diaphragms resonate at a resonance frequency between 200 Hz and 300 Hz, which is able to better present the low-frequency portion of the sound signal, thereby providing a better musical effect. In addition, in the case where the first diaphragm 221 and the second diaphragm 231 are the same, there is no need to separately manufacture the first diaphragm 221 and the second diaphragm 231, and the type of material for manufacturing may be reduced, thereby reducing cost and production difficulty.

In some embodiments, shown in conjunction with FIG. 3 to FIG. 5, the first diaphragm 221 and the second diaphragm 231 are disposed on both sides of the first symmetry plane A1, and the first diaphragm 221 and the second diaphragm 231 are disposed relative to the first symmetry plane A1 symmetrically. The two sides of the first symmetry plane A1 refer to two sides of the first symmetry plane A1 in a direction perpendicular to the first symmetry plane A1. That the first diaphragm 221 and the second diaphragm 231 are symmetrical with respect to the first symmetry plane A1 refers to the two diaphragms are mirror-symmetric about the first symmetry plane A1.

In some embodiments, since the first diaphragm 221 and the second diaphragm 231 are the same and mirror-symmetric about the first symmetry plane A1, the cost and the difficulty of production may be further reduced.

Further, in the case where the first diaphragm 221 and the second diaphragm 231 are mirror-symmetric about the first symmetry plane A1, a first magnetic circuit assembly (e.g., the first magnet 222, the first magnetic conductive shield 223, etc.) and a second magnetic circuit assembly (e.g., the second magnet 232, the second magnetic conductive shield 233, etc.) may be mirror-symmetric about the first symmetry plane A1, and the first acoustic driver 220 and the second acoustic driver 230 may be mirror-symmetric about the first symmetry plane A1, which can reduce the type of material used to manufacture the sound production portion 21, and even further reduce the cost and difficulty of production. Meanwhile, when the first acoustic driver 220 and the second acoustic driver 230 are mirror-symmetric about the first symmetry plane A1, the overall structure composed of the first acoustic driver 220 and the second acoustic driver 230 is more similar in shape to a sphere, sphere-like, or fusiform body, further adapting the shape of the accommodating cavity 211 for the purpose of fully utilizing the space of the accommodating cavity 211.

In some embodiments, the first diaphragm 221 and the second diaphragm 231 may be approximately symmetrical (i.e., not perfectly symmetrical) with respect to the first symmetry plane A1. Merly way of example, an angle between a plane where the first diaphragm 221 is located and the first symmetry plane A1 is a first angle, and an angle between a plane where the second diaphragm 231 is located and the first symmetry plane A1 is a second angle. When a difference between the first angle and the second angle is in the range from 0 to 5 degrees, it may be considered that the first diaphragm 221 and the second diaphragm 231 are approximately symmetrical relative to the first symmetry plane A1.

In some alternative embodiments, the first diaphragm 221 and the second diaphragm 231 may be symmetrical with respect to another plane different from the first symmetry plane A1. By way of example only, the first diaphragm 221 and the second diaphragm 231 may be disposed on two sides of a first parallel symmetry plane and symmetrical with respect to the first parallel symmetry plane. The first parallel symmetry plane may be parallel to the first symmetry plane A1. But a distance between the first diaphragm 221 and the first symmetry plane A1 and a distance between the second diaphragm 231 and the first symmetry plane A1 are different.

In some embodiments, an angle between a central axis of the sound outlet hole 240 and a central axis of the first sound transmission channel 212 may be less than a certain value, so that sound waves in the first sound transmission channel 212 are more smoothly conducted out through the sound outlet hole 240, thereby improving the quality of sound production.

In some embodiments, the angle between a central axis of the sound outlet hole 240 and a central axis of the first sound transmission channel 212 may be less than 30 degrees. In some embodiments, the angle between a central axis of the sound outlet hole 240 and a central axis of the first sound transmission channel 212 may be less than 15 degrees. In some embodiments, the angle between a central axis of the sound outlet hole 240 and a central axis of the first sound transmission channel 212 may be less than 5 degrees. In some embodiments, the central axis of the sound outlet hole 240 may be parallel to the central axis of the first sound transmission channel 212. Merely by way of example, the central axis of the sound outlet hole 240 is a first central axis. The central axis of the first sound transmission channel 212 is a second central axis. A distance between the first central axis and the second central axis is a first distance. A distance between the plane where the first diaphragm 221 is located and the plane where the second diaphragm 231 is located is a second distance. A ratio of the first distance to the second distance is less than a preset distance ratio. Exemplary preset distance ratio may include 20%, 10%, 5%, or the like.

In some embodiments, the central axis of the sound outlet hole 240 coincides with the central axis of the first sound transmission channel 212, a shape of a cross-section of the sound outlet hole 240 in a direction perpendicular to the central axis of the sound outlet hole 240 is the same as a shape of a cross-section of the first sound transmission channel 212 in a direction perpendicular to the central axis of the first sound transmission channel 212, and an inlet of the sound outlet hole 240 aligns with an opening of the first sound transmission channel 212. That the inlet of the sound outlet hole 240 aligns with the opening of the first sound transmission channel 212 refers to an edge of the inlet of the sound outlet hole 240 is flush with an edge of the opening of the first sound transmission channel 212.

In some embodiments, shown in conjunction with FIG. 1 to FIG. 5, the sound outlet hole 240 may be provided on the side of the housing 210 away from the ear hook 27 to allow the sound outlet hole 240 to be oriented toward the concha cavity of the wearer in the wearing state.

In some embodiments, the first symmetry plane A1 may pass through the sound outlet hole 240. In some embodiments, the sound outlet hole 240 may be provided centrally or offset on the housing 210. For example, the sound outlet hole 240 has an elongated shape. Along a length direction of the sound outlet hole 240, the first symmetry plane A1 may divide the sound outlet hole 240 into two symmetrical portions. As another example, when the sound outlet hole 240 is arranged on the housing 210, an outer end surface of the sound outlet hole 240 is non-symmetrical about the first symmetry plane A1.

In some embodiments, an inner end surface of the sound outlet hole 240 is flush with an inner wall surface of the housing 210, and the outer end surface of the sound outlet hole 240 is flush with an outer wall surface of the housing 210. In some embodiments, the outer end surface of the sound outlet hole 240 projected on the first symmetry plane A1 may form an arc segment. A projection of the housing 210 on the first symmetry plane A1 has an arc outer profile. At least a portion of the arc outer profile overlaps the arc segment. For ease of description, the arc segment formed by the projection of the outer end surface of the sound outlet hole 240 on the first symmetry plane A1 is simply referred to as the arc segment of the sound outlet hole 240; the arc outer profile of the projection of the housing 210 on the first symmetry plane A1 is simply referred to the arc outer profile of the housing 210. In some embodiments, the sound production portion 21 (or the housing 210) may be spheroidal in shape overall, and the projection of the housing 210 on the first symmetry plane A1 may have the arc outer profile. Because the sound outlet hole 240 is opened on the housing 210 of the sound production portion 21, the outer end surface of the sound outlet hole 240 has an arc structure. Based on this, it may be seen that the projection of the outer end surface of the sound outlet hole 240 on the first symmetry plane A1 may form the arc segment. Furthermore, when the outer end surface of the sound outlet hole 240 is symmetrical about the first symmetry plane A1, the arc segment of the sound outlet hole 240 overlaps at least a portion of the arc outer profile of the housing 210.

By designing the sound outlet hole 240 as the elongated shape and a projection of a long side of the elongated shape on the first symmetry plane A1 to form an arc segment having a certain arc length, the ear-clip earphone 200 may be adapt to people having different ear sizes and ear shapes. Specifically, in conjunction with what is shown in FIG. 1, FIG. 3, and FIG. 5, when the sound production portion 21 is inserted into the concha cavity 102 at different depths or sizes, different regions on the sound production portion 21 may be blocked to varying degrees by an inner wall of the concha cavity 102, or the region on the housing 210 of the sound production portion 21 facing the ear canal may undergo changes. The elongated sound outlet hole 240 with the first symmetry plane A1 as the symmetry plane ensures that the sound outlet hole 240 always has a certain area that can directly face the ear canal. in most scenarios, thereby improving the sound quality of the earphone. In addition, by setting at least a portion of the arc outer profile of the housing 210 to overlap with the arc segment of the sound outlet hole 240, it may be ensured that the outer end surface of the sound outlet hole 240 is symmetrical about the first symmetry plane A1. This ensures that, in the wearing state, a portion of the sound outlet 240 is blocked by the wall of the concha cavity, causing the sound field of the sound exported from the sound outlet hole 240 to form a reflected sound field, which forms the reflection reinforcement, thereby increasing the volume perceived by the wearer.

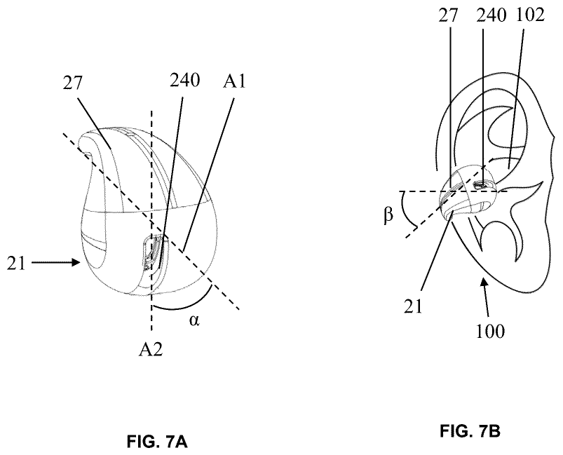

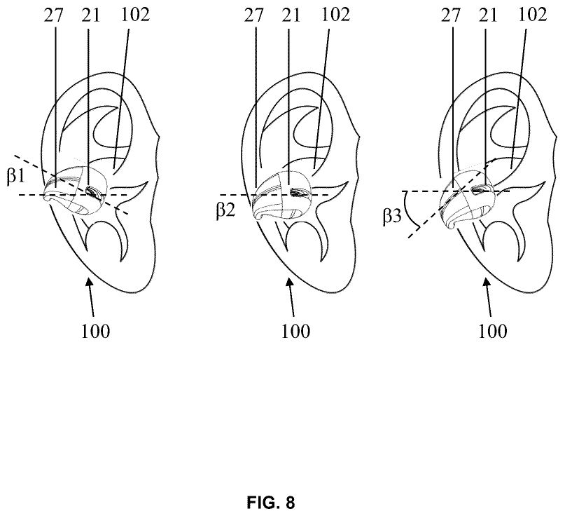

FIG. 7A is a schematic diagram of a location of a sound outlet hole according to some embodiments of the present disclosure. FIG. 7B is a schematic diagram of an ear-clip earphone in a wearing state according to some embodiments of the present disclosure. FIG. 8 is a schematic diagram of wearing states at different β-angles according to some embodiments of the present disclosure. In some embodiments, in conjunction with those shown in FIG. 3 to FIG. 8, by changing the position of the sound outlet hole 240 in the sound production portion 21, the output volume of the ear-clip earphone 200 at the ear canal of the wearer may be adjusted. Usually, the higher the output volume of the ear-clip earphone 200 toward the ear canal, the louder sound the wearer may experience with the same output power, which may reduce the energy consumption of the ear-clip earphone 200 and reduce sound leakage.

In some embodiments, as shown in conjunction with FIG. 2 to FIG. 5, FIG. 7A, FIG. 7B, and FIG. 8, to change the position of the sound outlet hole 240 in the sound production portion 21, it is necessary to make adjustments to the first diaphragm 221 and the second diaphragm 231. For example, the first diaphragm 221 and the second diaphragm 231 are adjusted to be symmetrical with respect to the second symmetry plane A2, wherein an inclination angle of less than 45 degrees is formed between the first symmetry plane A1 and the second symmetry plane A2. At this time, if the central axis of the sound outlet hole 240 coincides with the central axis of the first sound transmission channel 212, the central axis of the sound outlet hole 240 also forms an inclination angle of less than 45 degrees with respect to the first symmetry plane A1, i.e. so that the sound outlet hole 240 is offset with respect to the first symmetry plane A1. In this design manner, even if the ear hook 27 is tilted with respect to the auricle during wear due to gravity (i.e., the middle region of the ear hook 27 slides down with respect to the sound production portion 21 toward the bottom of the auricle as shown in FIG. 7B), the sound outlet hole 240 may still be oriented toward the ear canal.

In other embodiments, shown in conjunction with FIG. 2 to FIG. 5, FIG. 7A, FIG. 7B, and FIG. 8, the sound outlet hole 240 is symmetrical with respect to a third symmetry plane (not embodied in the figures). The third symmetry plane is perpendicular to a contact region of the sound outlet hole 240 with the inner wall of the concha cavity 102, and an inclination angle of less than 45 is formed between the first symmetry plane A1 and the third symmetry plane. The contact region refers to a portion of the outer end surface of the sound outlet hole 240 that is in contact with the inner wall of the concha cavity 102. The present embodiment describes the offset of the sound outlet hole 240 through another perspective and is intended to illustrate that even if the ear hook 27 is tilted with respect to the auricle during wear due to gravity (i.e., the middle region of the ear hook 27 slides down with respect to the sound production portion 21 toward the bottom of the auricle as shown in FIG. 7B), the sound outlet hole 240 may still be oriented toward the ear canal.

In some embodiments, as shown in conjunction with FIG. 1, FIG. 3 to FIG. 8, the sound outlet hole 240 may have elongated shape. The length direction of the sound outlet hole 240 is parallel to the first symmetry plane A1. An angle between a normal straight line of the sound outlet hole 240 pointing outward from the sound production portion 21 (i.e., the central axis of the sound outlet hole 240) and a symmetry plane in the length direction of the ear hook (i.e., the first symmetry plane A1) is defined as α, and an angle between the first symmetry plane A1 and the horizontal plane of the human body is defined as β. The horizontal plane of the human body refers to a plane that cuts across the upright human body parallel to the ground. In some embodiments, FIG. 8 illustrates the angles β1, β2, and β3, between the first symmetry plane A1 and the horizontal plane of the human body for the earphone in three placement cases, respectively, wherein, β1=−20°, β2=0°, and β3=45°. When α=0°, the first symmetry plane A1 passes through the central axis of the sound outlet hole 240. When β=0°, the first symmetry plane A1 is parallel to the horizontal plane of the human body. At this time, if α is in the range of 15°-45°, the frequency response curve of the ear-clip earphone 200 has the highest sound pressure level (SPL), i.e., the output volume is maximum. When the ear-clip earphone 200 are worn, β is usually located in a range of 0°-30° due to gravity. Therefore, by configuring the sound outlet hole 240 so that the angle a between the normal straight line of the sound outlet hole 240 and the first symmetry plane A1 is in a range of 15°-45° when β is equal to 0° (i.e., the first symmetry plane A1 is parallel to the horizontal plane of the human body), the audio volume can be increased in wearing scenarios where β is in a range of 0° to 30°.

In some embodiments, when the wearer wears the ear-clip earphone 200, the sound outlet hole 240 may be disposed entirely on the side of the first symmetry plane A1 close to an earlobe of the wearer to further ensure that the sound outlet hole 240 of the ear-clip earphone 200 may be oriented toward the ear canal even if the ear-clip earphone 200 are tilted while being worn due to gravity and other factors, thereby ensuring the listening effect and the listening volume.

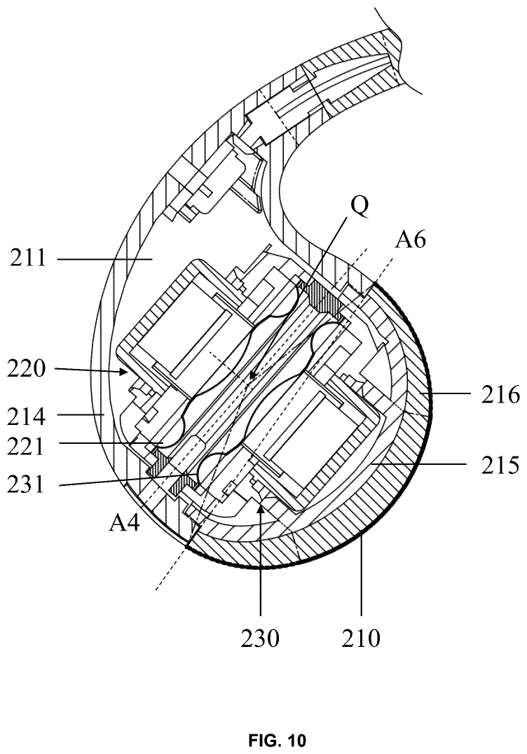

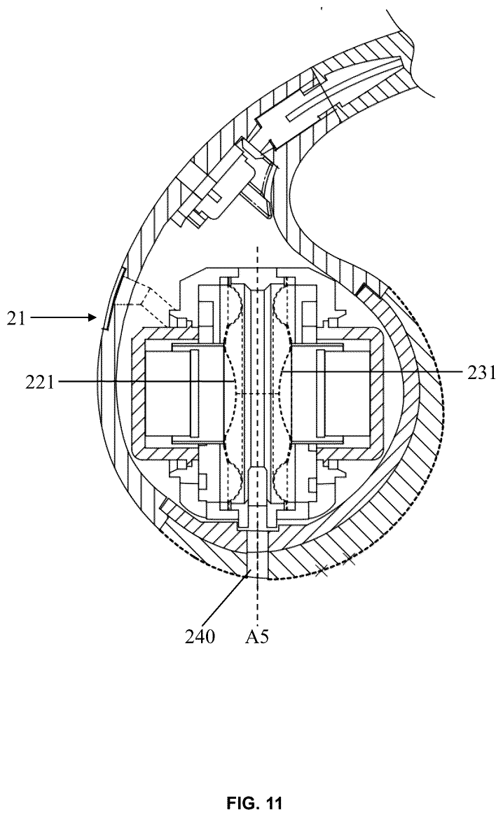

It is to be noted that FIG. 3 to FIG. 8 and the embodiments thereof are only used to illustrate an exemplary structure of the sound production portion 21, and do not intend to restrict the specific structure of the sound production portion 21, and that, after understanding the basic principles of the sound production portion 21, the structure of the sound production portion 21 may be adjusted according to the actual situation. FIG. 9-FIG. 11 illustrate two arrangements of the sound production portion in the housing, respectively. In some embodiments, as shown in FIG. 9 to FIG. 10, the first diaphragm 221 and the second diaphragm 231 of the sound production portion 21 may be symmetrical with respect to a fourth symmetry plane A4 perpendicular to the first symmetry plane A1. In some embodiments, the positions of the first diaphragm 221 and the second diaphragm 231 need to be adjusted to change the position of the sound outlet hole 240 in the sound production portion 21. For example, as shown in FIG. 11, the first diaphragm 221 and the second diaphragm 231 are adjusted to be symmetrical to a fifth symmetry plane A5. An inclination angle of less than 45 degrees is formed between the fifth symmetry plane A5 and the fourth symmetry plane A4, and the fifth symmetry plane A5 is perpendicular to the first symmetry plane A1. In some embodiments, when the first diaphragm 221 and the second diaphragm 231 are symmetrical to the fourth symmetry plane A4 or the fifth symmetry plane A5, the central axis of the sound outlet hole 240 may coincide with the central axis of the first sound transmission channel 212, and a shape of a cross-section of the sound outlet hole 240 in a direction perpendicular to the central axis of the sound outlet hole 240 is the same as a shape of the cross-section of the first sound transmission channel 212 in a direction perpendicular to the central axis of the first sound transmission channel 212, and the entrance of the sound outlet hole 240 is aligned with the opening of the first sound transmission channel 212. In other embodiments, in order to ensure that the sound outlet hole 240 may point towards the ear canal when the ear-clip earphone 200 are tilted under gravity, the sound outlet hole 240 may be completely located on the side of the first symmetry plane A1 close to the earlobe of the wearer when the wearer wears the ear-clip earphone 200.

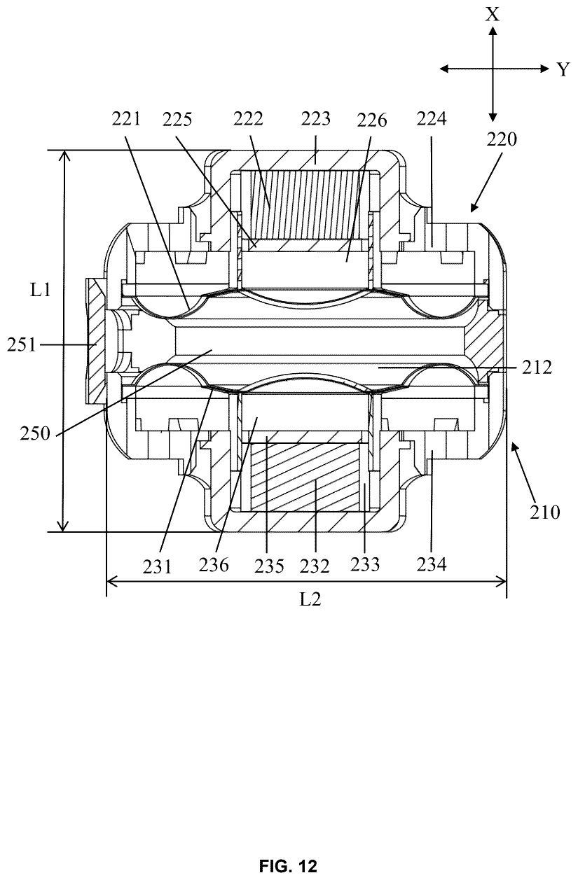

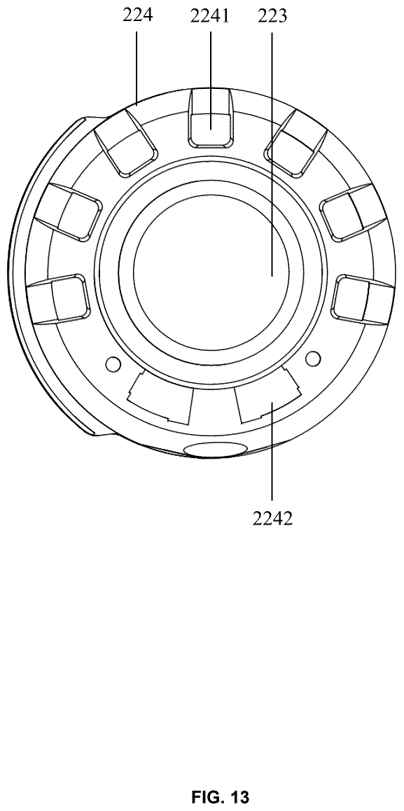

FIG. 12 is a schematic diagram of cross-sections of two acoustic drivers in a plane in which an axial direction and a radial direction of a first magnetic conductive shield are located according to some embodiments of the present disclosure. FIG. 13 is a top view of a first acoustic driver, a second acoustic driver, and a mounting bracket when connected according to some embodiments of the present disclosure. As shown in conjunction with FIG. 3 to FIG. 4 and FIG. 12 to FIG. 13, the first acoustic driver 220 includes a first magnet 222, a first magnetic conductive shield 223, and a first frame 224 disposed in sequence away from the first diaphragm 221. The first frame 224 supports the first diaphragm 221, the first magnet 222, and the first magnetic conductive shield 223. The first frame 224 includes a plurality of first air transmission holes 2241. The second acoustic driver 230 includes a second magnet 232, a second magnetic conductive shield 233, and a second frame 234 disposed in sequence away from the second diaphragm 221. The second frame 224 supports the second diaphragm 221, the second magnet 222, and the second magnetic conductive shield 223. The second frame 234 includes a plurality of second air transmission holes (not shown in the figures).

The first magnetic conductive shield 223 has an open end and a closed end, and the open end of the first magnetic conductive shield 223 is disposed toward the first diaphragm 221. The first magnet 222 is disposed within the first magnetic conductive shield 223, and an end of the first magnet 222 away from the first diaphragm 221 is connected to an inner wall of the closed end of the first magnetic conductive shield 223. The first frame 224 is enclosed around the first diaphragm 221, and an end of the first frame 224 away from the first diaphragm 221 is open with a first mounting hole. The first magnetic conductive shield 223 passes through the first mounting hole, and an outer side of the first magnetic conductive shield 223 is connected to a wall of the first mounting hole. The first frame 224, the first magnetic conductive shield 223, and the first diaphragm 221 together form a cavity used as a rear cavity of the first acoustic driver 220. Similarly, the second magnetic conductive shield 233 has an open end and a closed end. The open end of the second magnetic conductive shield 233 is disposed toward the second diaphragm 231, the second magnet 232 is disposed within the second magnetic conductive shield 233, and the end of the second magnet 232 away from the second diaphragm 231 is connected to an inner wall of the closed end of the second magnetic conductive shield 233. The second frame 234 is enclosed around the second diaphragm 231, and an end of the second frame 234 away from the second diaphragm 231 is provided with a second mounting hole. The second magnetic conductive shield 233 passes through the second mounting hole and an outer side of the second magnetic conductive shield 233 is connected to a wall of the second mounting hole. The second frame 234, the second magnetic conductive shield 233, and the second diaphragm 231 together form a cavity used as a rear cavity of the second acoustic driver 230.

Magnets (including the first magnet 222 and the second magnet 232) may be used to generate a magnetic field. When the strength of the magnetic field generated by the magnets changes, it will lead to a change in a force subjected by the corresponding diaphragm, which will make the corresponding diaphragm vibrate, and the vibration of the diaphragm will lead to a vibration of the air in the first sound transmission channel 212, thereby generating a sound wave. A magnetic conductive shield may be used to suppress magnetic leakage from the magnetic circuit assembly of the acoustic drivers. A frame is mainly used to support and fix a magnetic circuit assembly of an acoustic driver.

In some embodiments, the material used to make the first magnetic conductive shield 223 and the second magnetic conductive shield 233 may include one or a combination of mild steel, silicon steel sheet, silicon steel sheet, or ferrite. In some embodiments, the first magnet 222, the first magnetic conductive shield 223, and the first frame 224 may be the same as or similar to the second magnet 232, the second magnetic conductive shield 233, and the second frame 234.

In some embodiments, the first frame 224 and the first magnetic conductive shield 223 may be connected by a bonding, a snap connection, a welding, riveting, or the like. For example, in the embodiment illustrated in FIG. 12, the connection of the first frame 224 and the first magnetic conductive shield 223 may be secured by a sealant. The second frame 234 and the second magnetic conductive shield 233 may also be connected by the same or similar connection as in the preceding embodiment.

It should be noted that the air transmission holes may not be limited to being provided on the frames. Merely by way of example, the plurality of first air transmission holes 2241 may be provided on a side wall of the first magnetic conductive shield 223, and the plurality of first air transmission holes 2241 may be arranged around the side wall of the first magnetic conductive shield 223. The plurality of second air transmission holes may be provided on a side wall of the second magnetic conductive shield 233, and the plurality of second air transmission holes may be arranged around the side wall of the second magnetic conductive shield 233. As another example, the plurality of first air transmission holes 2241 may be disposed at the closed end of the first magnetic conductive shield 223, and the plurality of first air transmission holes 2241 may be arranged along an edge of the closed end of the first magnetic conductive shield 223. The plurality of second air transmission holes may be provided at the closed end of the second magnetic conductive shield 233, and the plurality of second air transmission holes may be arranged along an edge of the closed end of the second magnetic conductive shield 233.

In some embodiments, the first acoustic driver 220 further includes a first magnetic conductive plate 225 disposed within the first frame 224, and the first magnetic conductive plate 225 is connected to the side of the first magnet 222 proximate to the first diaphragm 221 for adjusting the distribution of the magnetic field generated by the first magnet 222. Similarly, the second acoustic driver 230 further includes a second magnetic conductive plate 235 disposed within the second frame 234, and the second magnetic conductive plate 235 is connected to the side of the second magnet 232 proximate the second diaphragm 231 for adjusting the distribution of the magnetic field generated by the second magnet 232. In some embodiments, the first magnetic conductive plate 225 and the second magnetic conductive plate 235 may be the same or similar.

In some embodiments, the first acoustic driver 220 further includes a first coil 226 disposed within the first frame 224. The first coil 226 is disposed around a side wall of the first magnet 222, and one end of the first coil 226 is connected to the first diaphragm 221. When the first coil 226 is energized with a current (e.g., the first coil 226 is connected to a first bonding pad 2242 on the first frame 224, and the current is energized to the first coil 226 through the first bonding pad 2242), the first coil 226 may vibrate and drive the first diaphragm 221 to vibrate under the action of the magnetic field. Similarly, the second acoustic driver 230 further includes a second coil 236 disposed within the second frame 234. The second coil 236 is disposed around a side wall of the second magnet 232, one end of the second coil 236 is connected to the second diaphragm 231. When the second coil 236 is energized with a current (e.g., the second coil 236 is connected to a second bonding pad (not illustrated in the figures) on the second frame 234, and a current is energized to the second coil 236 through the second bonding pad), the second coil 236 may vibrate and drive the second diaphragm 231 in response to the magnetic field. In some embodiments, the first coil 226 and the second coil 236 may be the same or similar.

In some embodiments, as shown in conjunction with FIG. 5 and FIG. 12, the first frame 224 and the second frame 234 are the same and symmetrical with respect to the first symmetry plane A1. The first magnetic conductive shield 223 and the second magnetic conductive shield 233 are the same and are symmetric with respect to the first symmetry plane A1. The first coil 226 and the second coil 236 are the same and are symmetrical with respect to the first symmetry plane A1. The two frames are the same and symmetrical, the magnetic conductive shields are the same and symmetrical, and the coils of the sound production portion 21 are the same and symmetrical, which can effectively improve the reusability of the various parts of the sound production portion 21, simplify the type of material required to manufacture the sound production portion 21, and reduce the cost and difficulty of production. In some embodiments, the first magnetic conductive plate 225 and the second magnetic conductive plate 235 are the same and symmetrical with respect to the first symmetry plane A1, and the first magnet 222 and the second magnet 232 are the same and symmetrical with respect to the first symmetry plane A1, thereby further improving the reusability of the various components of the sound production portion 21, simplifying the types of materials required to manufacture the sound production portion 21, and reducing the cost and the difficulty of production.

In some embodiments, as shown in FIG. 12, the sound production portion 21 further includes a mounting bracket 250, and the first acoustic driver 220 and the second acoustic driver 230 are mounted together on the mounting bracket 250. For example, the first frame 224 is coupled to the mounting bracket 250. The first magnetic conductive plate 225, the first magnet 222, the first magnetic conductive shield 223, and the first diaphragm 221 of the first acoustic driver 220 are all connected to the mounting bracket 250 via the first frame 224, i.e., the first acoustic driver 220 is mounted on the mounting bracket 250 via the first frame 224. Similarly, the second frame 234 is connected to the mounting bracket 250. The second magnetic conductive plate 235, the second magnet 232, the second magnetic conductive shield 233, and the second diaphragm 231 of the second acoustic driver 230 are all connected to the mounting bracket 250 via the second frame 234, i.e., the second acoustic driver 230 is mounted to the mounting bracket 250 via the second frame 234.

In some embodiments, both the first acoustic driver 220 and the second acoustic driver 230 are mounted on the same mounting bracket 250. For example, the mounting bracket 250 is primarily located between the first acoustic driver and the second acoustic driver, and a portion of the mounting bracket 250 may be co-enclosed with the first acoustic driver and the second acoustic driver to form a first transmission channel cavity (i.e., the first sound transmission channel 212). In such a manner, the overall structure of the sound production portion 21 may be simplified, and the manufacturing cost of the sound production portion 21 may be reduced. And, the adjustment of the shared cavity of the first acoustic driver 220 and the second acoustic driver 230 may be realized only by the design of the mounting bracket 250, thereby avoiding the influence of the complex structure inside the housing 210 on the acoustic effect of the shared cavity.

In some embodiments, sealant may be filled between the first frame 224 and the mounting bracket 250 and sealant may be filled between the second frame 234 and the mounting bracket 250 to ensure that the mounting bracket 250 is tightly connected to the first frame 224 and the second frame 234, and the sealant can provide a certain elastic buffer space for the overall structure formed by the first acoustic driver 220, the second acoustic driver 230, and the mounting bracket 250 when assembled with the first rigid shell 214 to reduce collision and extrusion between parts.

In some embodiments, as shown in conjunction with FIG. 1, FIG. 2, and FIG. 12, when an external shape of the housing 210 is a shape adapted to the concha cavity, such as a fusiform body, a sphere, a spheroid, etc., the overall structure formed by the first acoustic driver 220, the second acoustic driver 230 and the mounting bracket 250 can be designed to better fit the shape of the accommodating cavity 211 of the housing 210, thus improving the efficiency of utilizing the accommodating cavity 211 while ensuring the wearing comfort of the ear-clip earphone 200, and further improving the sound production efficiency of the sound production portion 21.

In some embodiments, as shown in conjunction with FIG. 3 and FIG. 12, a maximum distance in an axial direction of the structure formed by the first acoustic driver 220, the second acoustic driver 230, and the mounting bracket 250 is a first dimension. The maximum distance in the axial direction of the structure formed by the first acoustic driver 220, the second acoustic driver 230, and the mounting bracket 250 refers to a distance between the end surface of the first magnetic conductive shield 223 away from the first diaphragm 221 and the end surface of the second magnetic conductive shield 233 away from the second diaphragm 231, which may be represented by L1 in FIG. 12. A maximum distance in a radial direction of the structure formed by the first acoustic driver 220, the second acoustic driver 230, and the mounting bracket 250 is a second dimension. In some embodiments, an outer peripheral wall of the mounting bracket 250, and the outer sidewalls of the first frame 224 and the second frame 234 are flush on the side away from the opening of the first sound transmission channel 212. On the side proximate to the opening of the first sound transmission channel 212, a protrusion 251 of the mounting bracket 250 protrudes from the outer sidewalls of the first frame 224 and the second frame 234. So the maximum distance in the radial direction of the structure formed by the first acoustic driver 220, the second acoustic driver 230, and the mounting bracket 250 refers to a distance between an end surface of the protrusion 251 of the mounting bracket 250 away from the first sound transmission channel 212 and a peripheral wall of the mounting bracket 250 away from the opening of the first sound transmission channel 212, which may be represented by L2 in FIG. 12. In some embodiments, the ratio of the first dimension to the second dimension is in a range of 0.7 to 1.3. In some embodiments, the ratio of the first dimension to the second dimension is in a range of 0.85 to 1.15. In some embodiments, the ratio of the first dimension to the second dimension is in a range of 0.9 to 1.1. In some embodiments, by narrowing the ratio of the first dimension to the second dimension, the overall structure formed by the first acoustic driver 220, the second acoustic driver 230, and the mounting bracket 250 can further adapt to the shape of the accommodating cavity 211.

In some application scenarios, the overall structure formed by the first acoustic driver 220, the second acoustic driver 230, and the mounting bracket 250 and the inner wall of the housing 210 do not perfectly tight fit, and in particular, there may be a gap between the outlet of the first sound transmission channel 212 and the inlet of the sound outlet hole 240 (i.e., the sound outlet hole 240 is close to an end surface of the accommodating cavity 211). And the sound from the first sound transmission channel 212 into the sound outlet hole 240 may pass through the gap into other sound transmission channels of the accommodating cavity 211, for example, the rear cavities of the acoustic drivers, which in turn may cause the corresponding diaphragm not to be able to form effective vibration, thus reducing the quality of the sound exported from the sound outlet hole 240. And in this embodiment, the mounting bracket 250 is provided with the protrusion 251 at a position corresponding to the sound outlet hole 240, and the protrusion 251 may be offset from the inner wall of the housing 210 to isolate the first sound transmission channel 212 from the other sound transmission channels in the accommodating cavity 211, thereby effectively preventing airflow leakage in the first sound transmission channel 212, and ensuring the quality of sound exported from the sound outlet hole 240.

As shown in FIG. 12, the mounting bracket 250 is of an annular structure. Along an axial direction of the mounting bracket 250, the first diaphragm 221 and the second diaphragm 231 are disposed on the two sides of the mounting bracket 250 respectively to form the first sound transmission channel 212 with the mounting bracket 250, and the mounting bracket 250 may serve as a sidewall of the first sound transmission channel 212. In addition, the first frame 224 and the second frame 234 are also disposed on the two sides of the mounting bracket 250 to form in the rear cavity of the first acoustic driver 220 and the second acoustic driver 230, respectively. A position of the mounting bracket 250 corresponding to the sound outlet hole 240 (i.e., the side of the mounting bracket 250 proximate to the sound outlet hole 240) is provided with the protrusion 251, which protrudes from between the first frame 224 and the second frame 234 and resists the inner wall of the housing 210, to isolate the first sound transmission channel 212 from other sound transmission channels in the accommodating cavity 211 (e.g., the rear cavities of the acoustic drivers).

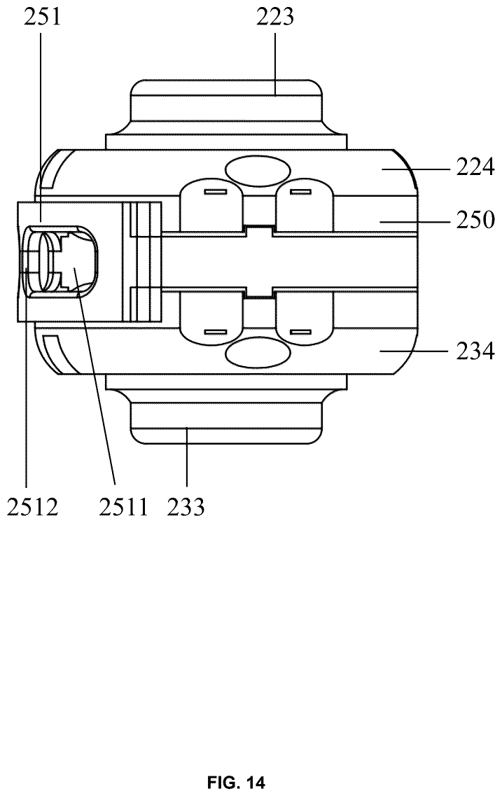

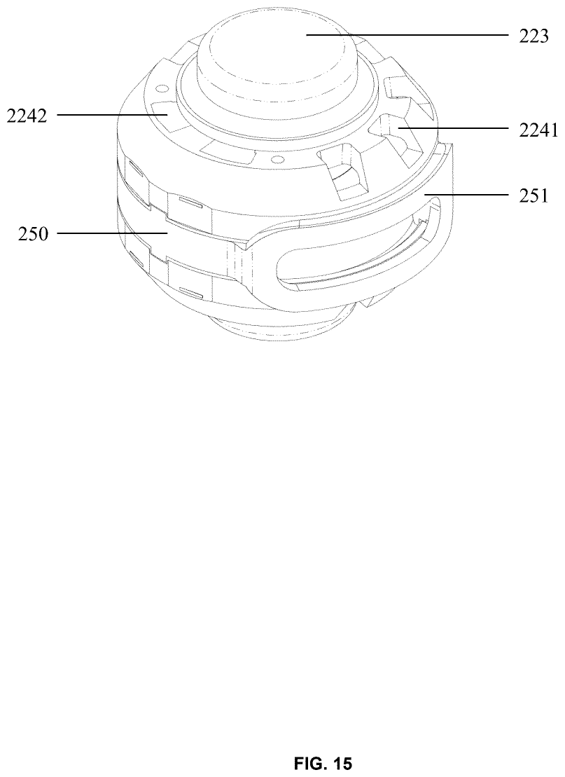

FIG. 14 is a front view of a first acoustic driver, a second acoustic driver, and a mounting bracket when connected according to some embodiments of the present disclosure. FIG. 15 is a schematic diagram of a structure of a first acoustic driver, a second acoustic driver, and a mounting bracket when connected according to another embodiment of this disclosure. As shown in conjunction with FIG. 12 to FIG. 14, the protrusion 251 of the mounting bracket 250 is provided with a plurality of through holes 2511. A reinforcing rib 2512 is provided between adjacent through holes 2511. First cross-sections of the through holes 2511 are flush with an end surface of the first frame 224. Second cross-sections of the through holes 2511 are flush with an end surface of the second frame 234. The first cross-section of a through hole 2511 refers to an inner wall surface of the through hole 2511 close to the first frame 224. The second cross-section of a through hole 2511 refers to an inner wall surface of the through hole 2511 close to the second frame 234. The end surface of the first frame 224 refers to an end surface of the first frame 224 proximate to the second frame 234. The end surface of the second frame 234 refers to an end surface of the second frame 234 close to the first frame 224.

For convenience of description, the overall structure formed by the first acoustic driver 220, the second acoustic driver 230, and the mounting bracket 250 may be referred to as a first overall structure. If the first acoustic driver 220 and the second acoustic driver 230 are disposed symmetrically, e.g., symmetrically with respect to a first symmetry plane (e.g., the first symmetry plane A1 in FIG. 3), then after flipping the first acoustic driver 220 by 180 degrees with respect to the first symmetry plane, the end surface of the first frame 224 of the first acoustic driver 220 may be flush with the second cross-section of the through hole 2511. At this time, an overall structure (also referred to as a second overall structure) formed by the two first acoustic drivers 220 and the mounting bracket 250 does not unchanged compared to the first overall structure, so in the second overall structure, it is equivalent to the first acoustic driver 220 being multiplexed as the second acoustic driver 230. Similarly, after flipping the second acoustic driver 230 180 degrees relative to the first symmetry plane, the end surface of the second frame 234 of the second acoustic driver 230 may be flush with the first cross-section of the through hole 2511. At this time, the overall structure (also referred to as the third overall structure) formed by the two second acoustic drivers 230 and the mounting bracket 250 also remains unchanged compared to the first overall structure, so that in the third overall structure, it is equivalent to the second acoustic driver 230 being multiplexed as the first acoustic driver 220. After being so set up, there is no need to separately produce and manufacture the first acoustic driver 220 and the second acoustic driver 230, and the first acoustic driver 220 and the second acoustic driver 230 may be mutually realized for reuse, effectively reducing the manufacturing cost.

In addition, in this embodiment, due to the presence of the reinforcing rib 2512, the structural strength of the protrusion 251 may be effectively improved, thereby preventing the mounting bracket 250 from being extruded and deformed. In some embodiments, the reinforcing rib 2512 is not a necessary structure for the protrusion 251, and the protrusion 251 is provided to isolate the first sound transmission channel 212 from other sound transmission channels (e.g., the rear cavities of the acoustic drivers) of the accommodating cavity (e.g., the accommodating cavity 211 in FIG. 3), and thus it is sufficient to ensure that the first sound transmission channel 212 and the sound outlet hole 240 are acoustically connected and that the isolation of the first sound transmission channel 212 from other sound transmission channels of the accommodating cavity. For example, in the embodiment shown in FIG. 15, the protrusion 251 may be an open-ended structure, with the sidewalls of the open-ended structure abutting against an inner wall of the housing (e.g., the housing 210 in FIG. 3).

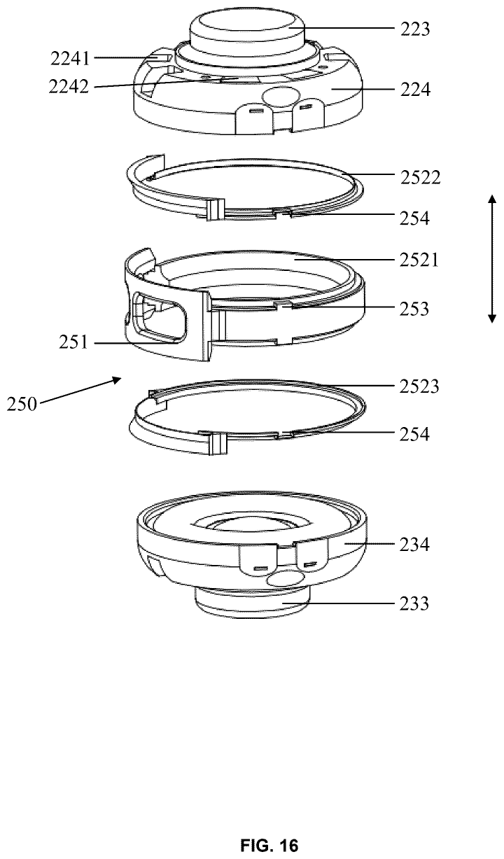

FIG. 16 is a schematic diagram of an assembly of a first acoustic driver, a second acoustic driver, and a mounting bracket according to some embodiments of the present disclosure. As shown in conjunction with FIG. 14 to FIG. 16, the mounting bracket 250 may include the protrusion 251 in the above embodiments and an annular notch portion 252 coupled to the protrusion 251, and the annular notch portion 252 may have only a positioning structure. The positioning structure is configured to locate the first frame 224 and the second frame 234 relative to the mounting bracket 250, and the positioning structure is a combination of a positioning protrusion 253 and a positioning groove 254. Merly way of example, the annular notch portion 252 may include a main body portion 2521, a first connecting portion 2522, and a second connecting portion 2523. The first connecting portion 2522 is used for connecting the main body portion 2521 to the first frame 224, and the second connection portion 2523 is used for connecting the main body portion 2521 and the second frame 234. The main body portion 2521 is provided with two positioning protrusions 253, the two positioning protrusions 253 are provided on both sides of the main body portion 2521 along an axial direction of the annular notch portion 252 (as shown by the arrows in FIG. 16), and each of the first connecting portion 2522 and the second connecting portion 2523 is provided with positioning grooves 254 adapted to the positioning protrusions 253. When the two positioning protrusions 253 are embedded in the two positioning grooves 254 respectively, the first frame 224 and the second frame 234 may be aligned with the mounting bracket 250 so that the first bonding pad 2242 and the second bonding pad 2342 are positioned relative to each other to facilitate the connection of external wires to the bonding pads and the connection between the bonding pads and the coils. In other embodiments, the mounting of the first frame 224 and the second frame 234 with the mounting bracket 250 may be positioned in other ways, for example, a magnetic adsorption structure, a snap slot structure, or the like.

In some embodiments, as shown in conjunction with FIG. 3, FIG. 12, and FIG. 13, the second sound transmission channel 213 is formed between the first frame 224 and the second frame 234. The side of the first diaphragm 221 away from the first sound transmission channel 212 is connected to the second sound transmission channel 213 through the first air transmission hole 2241. The side of the second diaphragm 231 away from the first sound transmission channel 212 is connected to the second sound transmission channel 213 through the second air transmission hole. Merely by way of example, the end surface of the first frame 224 away from the first diaphragm 221 and the end surface of the second frame 234 away from the second diaphragm 231 have a gap with the inner wall of the housing 210, so the first frame 224, the second frame 234, and the housing 210 may form a second sound transmission channel 213, and the cavity close to the end surface of the first frame 224 away from the first diaphragm 221 and the cavity close to the end surface of the second frame 234 away from the second diaphragm 231 may be acoustically connected. The rear cavity of the first acoustic driver 220 is formed between the first diaphragm 221, the first frame 224, and the first magnetic conductive shield 223. The rear cavity of the second acoustic driver 230 is formed between the second diaphragm 231, the second frame 234, and the second magnetic conductive shield 233. The rear cavity of the first acoustic driver 220 and the rear cavity of the second acoustic driver 230 may be acoustically connected to the second sound transmission channel 213 through the first air transmission hole 2241 and the second air transmission hole, respectively. At this time the rear cavity of the first acoustic driver 220, the rear cavity of the second acoustic driver 230, and the second sound transmission channel 213 may together form a cavity as the rear cavity of the sound production portion 21, which is equivalent to the common rear cavity shared by the first acoustic driver 220 and the second acoustic driver 230.

In some embodiments, the rear cavity of the first acoustic driver 220 and the rear cavity of the second acoustic driver 230 are acoustically connected, and airflow in the rear cavities of the two acoustic drivers may be directed outside of the housing 210 through the same pressure relief hole (e.g., the pressure relief hole 217 in FIG. 18), which can simplify the overall structure of the sound production portion 21 and reduce the manufacturing cost of the sound production portion 21.

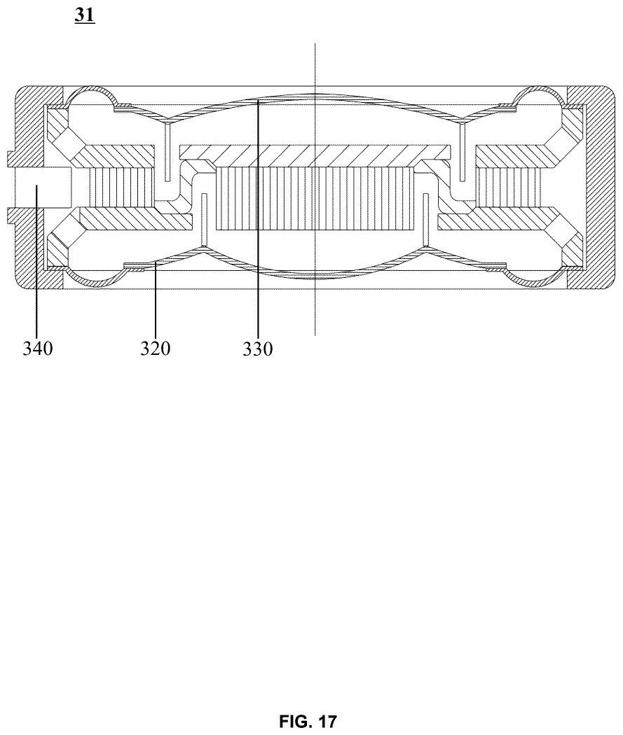

FIG. 17 is a schematic diagram of a cross-section of another sound production portion in a plane in which an axial direction and a radial direction of a first magnetic conductive shield are located according to some embodiments of the present disclosure. The difference with the sound production portion 21 in FIG. 12 is that the two acoustic drivers (a third acoustic driver 320, a fourth acoustic driver 330) of a sound production portion 31 in FIG. 17 share a common rear cavity, and the rear cavities of the third acoustic driver 320 and the fourth acoustic driver 330 are in acoustic communication with the sound outlet hole 340.

In some embodiments, the first acoustic driver 220 and the second acoustic driver 230 may share both the front cavity and the rear cavity, thereby further simplifying the overall structure of the sound production portion 21 and reducing the manufacturing cost of the sound production portion 21.

FIG. 18 is a schematic diagram of a structure of an ear-clip earphone according to some embodiments of the present disclosure. In some embodiments, see FIG. 18 shown herein, the ear-clip earphone 200 may further include the pressure relief hole 217. The pressure relief hole 217 is disposed on the housing 210 of the sound production portion 21. As shown in conjunction with FIG. 1, FIG. 3, FIG. 16, and FIG. 18, when worn, the pressure relief hole 217 is disposed in the housing 210 proximate to the ear hook 27 and toward an opening of the concha cavity 102 of the wearer. In some embodiments, the pressure relief hole 217 is acoustically connected to the second sound transmission channel 213, and in turn, acoustically connected to the rear cavities of the first acoustic driver 220 and the second acoustic driver 230, to export the sound in the rear cavities to the outside, thereby balancing the sound pressure in the rear cavities, so that the diaphragm of the sound production portion 21 can vibrate sufficiently at a large amplitude at a low frequency to ensure the fullness of the low frequencies.

In some embodiments, as shown in conjunction with FIG. 16 and FIG. 18, the first frame 224 is provided with the plurality of first air transmission holes 2241 at the end surface away from the first diaphragm 221, and the plurality of first air transmission holes 2241 are arranged at intervals around the first magnetic conductive shield 223. The first frame 224 is further provided with a plurality of first bonding pads 2242 on the end surface away from the first diaphragm 221. The first bonding pads 2242 may be used to energize the first coil 226. A minimum distance between at least a portion of the first bonding pads 2242 and the pressure relief hole 217 is a first minimum distance, and a minimum distance between at least a portion of the first air transmission holes 2241 and the pressure relief holes 217 is a second minimum distance, and the first minimum distance is greater than the second minimum distance. The distance between the first bonding pads 2242 and the pressure relief hole 217 refers to a distance between the centroid of the first bonding pads 2242 and the centroid of the pressure relief hole 217. The distance between the first air transmission holes 2241 and the pressure relief hole 217 refers to a distance between the centroid of the first air transmission holes 2241 and the centroid of the pressure relief hole 217.

Similarly, a plurality of second air transmission holes (not shown in the figures) are provided on the end surface of the second frame 234 away from the second diaphragm 231, and the plurality of second air transmission holes are arranged at intervals around the second magnetic conductive shield 233. The second frame 234 is also provided with a plurality of second bonding pads (not shown in the figures) on the end surface away from the second diaphragm 231. The second bonding pads may be used to energize the second coil 236. A minimum distance between at least a portion of the second bonding pads and the pressure relief hole 217 is a third minimum distance, a minimum distance between at least a portion of the second air transmission holes and the pressure relief hole 217 is a fourth minimum distance, and the third minimum distance is greater than the fourth minimum distance.

In some embodiments, by causing the first air transmission hole 2241 and the second air transmission hole to close to the pressure relief hole 217, it is possible to allow the airflow in the rear cavities of the first acoustic driver 220 and the second acoustic driver 230 to be discharged from the pressure relief hole 217 by a shorter distance, improving the efficiency of releasing the air pressure in the rear cavities of the first acoustic driver 220 and the second acoustic driver 230, and improving the quality of sound production.

In other embodiments, an average distance of distances from all first air transmission holes 2241 to the pressure relief hole 217 is a first average distance, an average distance of distances from all first bonding pads 2242 to the pressure relief hole 217 is a second average distance, and the first average distance is less than the second average distance. By the above two ways, it is also possible to make the air transmission holes closer to the pressure relief hole 217 compared to the bonding pads, so that the airflow in the rear cavities of the acoustic drivers may be discharged from the pressure relief hole 217 in a shorter distance, improving the efficiency of air pressure release in the rear cavities.

In some embodiments, the first minimum distance may be less than 1.5 mm, and the second minimum distance may be less than 0.8 mm. In some embodiments, the first minimum distance may be less than 1 mm, and the second minimum distance may be less than 0.6 mm. Similarly, in some embodiments, the third minimum distance may be less than 1.5 mm and the fourth minimum distance may be less than 0.8 mm. In some embodiments, the third minimum distance may be less than 1 mm and the fourth minimum distance may be less than 0.6 mm.

In some embodiments, as shown in FIG. 18, the pressure relief hole 217 may include a first end 2171, a second end 2172, and a connection segment 2173 connecting the first end 2171 and the second end 2172. The first end 2171, the second end 2172, and the connection segment 2173 are provided along a length direction of the pressure relief hole 217, so that a minimum width of the first end 2171 and the second end 2172 is greater than a maximum width of the connection segment 2172, so that the shape of the pressure relief hole 217 is similar to a “bone shape”.

In some embodiments, as shown in conjunction with FIG. 1, FIG. 5, and FIG. 18. The pressure relief hole 217 may be symmetric with respect to the first symmetry plane A1. After being so set up, whether the ear-clip earphone 200 is worn on the left or right ear of the wearer, the ear-clip earphone 200 will not have a large impact on the pressure relief effect of the pressure relief hole 217.

In some embodiments, as shown in conjunction with FIG. 1, FIG. 3, FIG. 16, and FIG. 18, the pressure relief hole 217 is located further away from the era canal as compared to the sound outlet hole 240 when the ear-clip earphone 200 is worn to attenuate the inverse phase cancellation between the sound outputted via the pressure relief hole 217 and the sound outputted via the sound outlet hole 240, thereby increasing the volume of sound heard by the wearer. In some embodiments, when wearing the ear-clip earphone 200, the sound outlet hole 240 are directed toward the ear canal while the pressure relief hole 217 are directed toward the side away from the ear canal, and at the same time, the housing 210 of the sound production portion 21 is pressed against the inner wall of the concha cavity 102, thereby isolating the sound outlet hole 240 from the pressure relief hole 217, avoiding the sound waves derived from the pressure relief hole 217 from interfering with the sound waves derived from the sound outlet hole 240, reducing sound short-circuiting, and improving the quality of sound production.

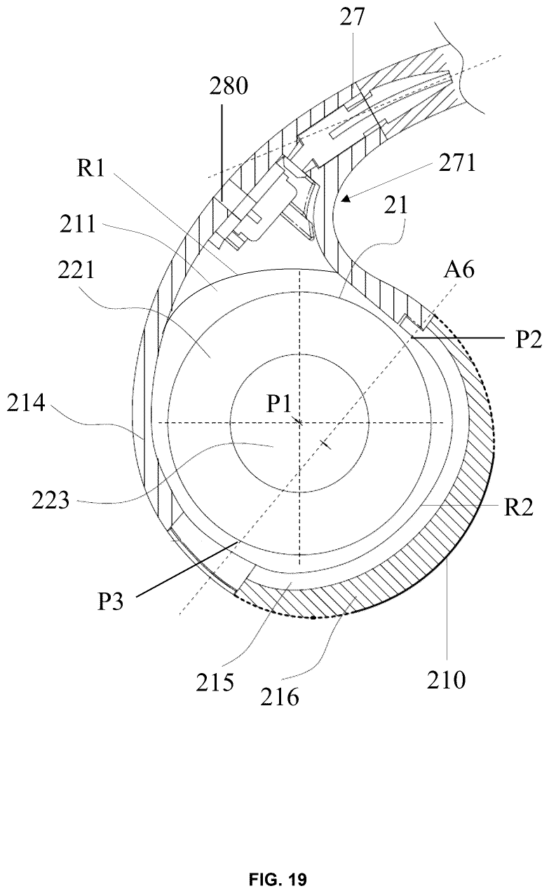

FIG. 19 is a schematic diagram of a cross-section of a sound production portion in a plane parallel to a first symmetry plane according to some embodiments of the present disclosure. In some embodiments, as shown in conjunction with FIG. 5, FIG. 18, and FIG. 19, an arcuate concave segment 271 is formed between the inner side of the ear hook 27 and the housing 210 of the sound production portion 21, a projection of the pressure relief hole 217 on the first symmetry plane A1 is disposed in the arcuate concave segment 271, and the bending degree of the arcuate concave segment 271 is greater than a certain threshold so that an inner contour of the arcuate concave segment 271 corresponding to the vicinity of the position at which the housing 21 is connected to the ear hook 27 is sufficiently recessed such that the pressure relief hole 217 disposed at the concave position may be unobstructed by the ear-hanging.

In some embodiments, the pressure relief holes 217 and a sound inlet hole 280 may be disposed on opposing sides of the ear hook 27. For example, when wearing the ear-clip earphone 200, the pressure relief hole 217 may be disposed on the side of the ear hook toward the antihelix, and the sound inlet hole 280 may be disposed on the side of the ear hook 27 toward the ear screen to improve the sound pickup effect of the microphone assembly, and the pressure relief hole 217 and the sound inlet holes 280 may be set relative to each other so that there is less mutual interference between the two.

Before connecting the first rigid shell 214 and the second rigid shell 215, it may be necessary to connect and secure the overall structure consisting of the two acoustic drivers with the mounting bracket 250 to the first rigid shell 214. In order to realize the connection of this overall structure with the first rigid shell 214, in some embodiments, as shown in conjunction with FIG. 3 and FIG. 5, a first step structure 218 and a second step structure 219 are disposed on an inner side of the housing 210. The first step structure 218 abuts against the first magnetic conductive shield 223 or the first frame 224. The second step structure 219 abuts against the second magnetic conductive shield 233 or the second frame 234. Merely by way of example, the first step structure 218 and the second step structure 219 may be disposed on both sides of the first symmetry plane A1 of the inner wall of the first rigid shell 214 respectively, and the first step structure 218 and the second step structures 219 are symmetrical with respect to the first symmetry plane A1. The first step structure 218 includes a first resisting portion and a second resisting portion. The first resisting portion abuts against the end surface of the first magnetic conductive shield 223 away from the first diaphragm 221. The second resisting portion abuts against an outer wall of the first magnetic conductive shield 223. The second step structure 219 includes a third resisting portion and a fourth resisting portion. The third resisting portion abuts against the end surface of the second magnetic conductive shield 233 away from the second diaphragm 231. The fourth resisting portion abuts against an outer wall of the second magnetic conductive shield 233.

The overall structure composed of the two acoustic drivers and the mounting bracket 250 may be restricted from moving in an axial direction of the overall structure (a direction parallel to the direction of vibration of the diaphragm) by the cooperation of the first resisting portion and the third resisting portion. By the cooperation of the second resisting portion and the fourth resisting portion, the overall structure composed of the two acoustic drivers and the mounting bracket 250 may be restricted from moving in a radial direction of the overall structure (a direction parallel to the radial direction of the first sound transmission channel 212) to the ear hook 27. Additionally, since the step structures abut against the first magnetic conductive shield 223 and the second magnetic conductive shield 233, it is possible to avoid the step structures from blocking the air transmission holes, thereby improving the pressure relief effect.

It is to be noted that the first step structure 218 and the second step structure 219 are illustrated in FIG. 3 are for illustrative purposes only, and are not intended to limit the specific form of the structure for realizing the positioning of the acoustic drivers with the housing 210. For example, the acoustic drivers may be positioned with the housing 210 by a structure such as a magnetic suction assembly, a snap-in slot assembly, a guide groove and guide rod assembly, or the like.

In some embodiments, the housing 210 of the ear-clip earphone 200 is made of rigid material (e.g., metal) or made of flexible material (e.g., rubber). However, the housing 210 made of rigid material lacks in wearing comfort, and the housing 210 made of flexible material is less supportive and less protective of the structures accommodated inside the housing 210, and thus does not effectively satisfy the requirements of the ear-clip earphone 200. In order to solve the above problems, some embodiments of the present disclosure provide that the internal cavity (i.e., the accommodating cavity 211) of the sound production portion 21 of the housing 210 of the ear-clip earphone 200 is enclosed by a rigid material, and a flexible body 216 is provided on the surface of the housing 210 in contact with the concha cavity of the wearer. In this way, while ensuring wearing comfort, the supportability and protection of the parts accommodated inside the housing 210 can be improved, and the sound quality of the ear-clip earphone 200 can be also improved.

In some embodiments, as shown in conjunction with FIG. 3 and FIG. 19, the housing 210 may include the first rigid shell 214, the second rigid shell 215, and a flexible body 216. The second rigid shell 215 is configured to be disposed toward the concha cavity of the wearer during wear. The flexible body 216 is configured to be in contact with the concha cavity of the wearer during wear. The first rigid shell 214 and the second rigid shell 215 enclose the accommodating cavity 211. The flexible body 216 covers the outer wall of the second rigid shell 215.

In this embodiment, the accommodating cavity 211 is enclosed by the first rigid shell 214 and the second rigid shell 215, and the first rigid shell 214 and the second rigid shell 215 are both made of rigid material, so that the first rigid shell 214 and the second rigid shell 215 may better support and fix the parts (e.g., the first acoustic driver 220, the second acoustic driver 230) in the accommodating cavity 211, which can effectively avoid deformation of the accommodating cavity 211 caused by external pressure to extrude the parts in the accommodating cavity 211, thereby improving the structural strength of the sound production portion 21 and improving the sound quality. In addition, since the flexible body 216 covers the outer wall of the second rigid shell 215, when the wearer wears the earphone, the flexible body 216 can contact the concha cavity of the wearer, to avoid direct contact of the second rigid shell with the concha cavity affecting the wearing tactile sensation, thereby effectively improving the wearing comfort. At the same time, because the flexible body 216 is mainly covered on the outer wall of the second rigid shell 215, it does not affect the external structure and internal space of the first rigid shell 214, thus reducing the size of the housing 210 under the premise of guaranteeing wearing comfort.

In some embodiments, the material making the first rigid shell 214 and the second rigid shell 215 may include plastic, metal, or other support materials capable of being used as a support material for the earphone housing 210. In some embodiments, the first rigid shell 214 and the second rigid shell 215 may be made of the same rigid material. In some embodiments, the first rigid shell 214 and the second rigid shell 215 may be made of different rigid materials.

In some embodiments, the material used to make the flexible body 216 is not limited to materials such as silicone, rubber, elastomeric resins, polyurethane materials, polydimethylsiloxane, PVC, TPE, or the like.

It should be noted that the housing 210 illustrated in FIG. 3 and FIG. 19 is for illustrative purposes only, and is not intended to limit the form of arrangement of the flexible body 216 in the embodiments of the present disclosure. In some embodiments, the flexible body 216 is provided on the exposed outer wall of the second rigid shell 215, except for the connection with the first rigid shell 214, as illustrated in conjunction with FIG. 5 and FIG. 19. In other embodiments, the flexible body 216 is provided on a portion of the exposed outer wall of the second rigid shell 215, except at the connection with the first rigid shell 214. Merely by way of example, a plane in which the outermost annulus of an end surface of the flexible body 216 is located is a first reference plane A6, and in a cross-section perpendicular to the first reference plane A6 and passing through the center of the first reference plane A6 (e.g., the cross-section may be a cross-section parallel to the first symmetry plane A1, or the cross-section may be the first symmetry plane A1), an area of the flexible body 216 that is covered by the second rigid shell 215 is greater than or equal to 80% of the curved length segment of the second rigid shell 215. As another example, an ear hook symmetry plane (i.e., the first symmetry plane A1) has two intersections with the outermost annulus of the end surface of the flexible body 216, and in a cross-section perpendicular to the ear hook symmetry plane A1 and passing through the two intersections, an area of the flexible body 216 that is covered by the second rigid shell 215 is greater than or equal to 80% of the curved length segment of the second rigid shell 215. The above two examples describe the percentage of the flexible body 216 on the second rigid shell 215 from two perspectives, respectively, such that the flexible body 216 can cover a sufficiently large area on the second rigid shell 215 to reduce or eliminate direct contact between the wearer and the second rigid shell 215.

In some embodiments, the first rigid shell 214 and the second rigid shell 215 may be connected by means including splicing, welding, snap connections, magnetic connections, or the like. Merely by way of example, an end portion of the second rigid shell 215 is secured by splicing with an end portion of the first rigid shell 214. The end portion of the second rigid shell 215 is secured to the end portion of the first rigid shell 214 through splicing to form a reliable, compact fixed relationship, and this splicing way also facilitates assembly and reduces the assembly process.

In the embodiments shown in FIG. 3 and FIG. 19, since the second rigid shell 215 is provided with the flexible body 216 on the outer wall of the second rigid shell 215, the wall thickness of the corresponding portion of the housing 210 is a combination of the wall thickness of the second rigid shell 215 and the wall thickness of the flexible body 216. Whereas the first rigid shell 214 is not provided with the flexible body 216 on the outer wall of the first rigid shell 214, or the first rigid shell 214 is provided with the flexible body 216 only on a portion of its outer wall proximate to the second rigid shell 215 (e.g., the portion of the first rigid shell 214 that is connected to the second rigid shell 215), the wall thickness of the corresponding portion of the housing 210 may be regarded as being the same or approximately the same as the wall thickness of the first rigid shell 214. Constrained by the small volume of the concha cavity, in the case where the overall dimension of the housing 210 is limited, the wall thickness of the corresponding portion of the housing 210 can be reduced due to that there is no flexible body provided on the outer wall of the first rigid shell 214, it is equivalent to increasing the volume of the internal space of the first rigid shell 214, thereby being capable of accommodating a larger diaphragm to form a better acoustic effect.

Furthermore, the internal space of the first rigid shell 214 is increased, which in turn causes the shape and size of the accommodating cavity 211 to change accordingly. In order to more fully utilize the internal space of the accommodating cavity 211, the arrangements of the first acoustic driver 220 and the second acoustic driver 230 needs to be adjusted. Variations in the arrangements of the first acoustic driver 220 and the second acoustic driver 230 will be described in the present disclosure in conjunction with FIG. 10 and FIG. 19 and their embodiments.

In some embodiments, in order to fully utilize the internal space of the accommodating cavity 211, a midpoint Q of a line connecting the center of the first diaphragm 221 and the center of the second diaphragm 231 may be substantially coincident with the center of the accommodating cavity 211. The center of a diaphragm refers to a center of a plane in which the diaphragm is located. that the midpoint Q is substantially coincident with the center of the accommodating cavity 211 means that a distance between the midpoint Q and the center of the accommodating cavity 211 does not exceed a preset value, e.g., 5 mm, 3 mm, 1 mm, etc. Merely by way of example, if the shape of the accommodating cavity 211 is a sphere, and an axial dimension and a radial dimension of the overall structure formed by the first acoustic driver 220, the second acoustic driver 230, and the mounting bracket 250 are the same substantially, then when the midpoint Q of the line connecting the center of the first diaphragm 221 and the center of the second diaphragm 231 coincides with the center of the accommodating cavity 211, the space of the accommodating cavity 211 may be more fully utilized. When the flexible body 216 is not provided, the center of the housing 210 and the center of the accommodating cavity 211 may be considered to be substantially coincident. And when the flexible body 216 is provided on the outer wall of the second rigid shell 215, the center of the housing 210 changes, and the midpoint Q of the line connecting the centers of the first diaphragm 221 and the second diaphragm 231 also deviates from the center of the housing 210. It should be noted that the first diaphragm 221 and the second diaphragm 231 may not be identical or perfectly symmetrical with respect to the first symmetry plane A1, for example, the first diaphragm 221 and the second diaphragm 231 may be approximately identical. As another example, the first diaphragm 221 and the second diaphragm 231 are approximately symmetrical (i.e., not perfectly symmetrical) with respect to the first symmetry plane A1.

In some embodiments, the plane in which the outermost annulus of the end surface of the flexible body 216 is located is the first reference plane A6, and the midpoint Q of the line connecting the center of the first diaphragm 221 and the center of the second diaphragm 231 is located outside the first reference plane A6. In this embodiment, the plane in which the outermost annulus of the end surface of the flexible body 216 is located corresponds to an interface between the interior space of the flexible body 216 and the interior space of the first rigid shell 214. When the shape and dimension of the internal space of the flexible body 216 are the same as or substantially the same as the shape and dimension of the internal space of the first rigid shell 214 and the midpoint Q coincides substantially with the center of the accommodating cavity 211 and the center of the housing 210, the midpoint Q may be regarded as that the midpoint Q is located on the first reference surface A6 or that a distance between the midpoint Q and the first reference surface A6 is small, so as to facilitate full utilization of the space of the accommodating cavity 211. Because the flexible body 216 is also provided on the second rigid shell 215, the center of the housing 210 is offset from the center of the accommodating cavity 211, and the midpoint Q is located outside the first reference surface A6.

In some embodiments, the plane in which the outermost annulus of the end surface of the second rigid shell 215 is located is a second reference plane (not embodied in the figures), and the midpoint Q of the line connecting the center of the first diaphragm 221 and the center of the second diaphragm 231 is located outside the second reference plane. The plane in which the outermost annulus of the end surface of the second rigid shell 215 is located corresponds to an interface between the interior space of the second rigid shell 215 and the interior space of the first rigid shell 214. When shapes and dimensions of the internal spaces of the second rigid shell 215 and the first rigid shell 214 are the same or substantially the same and the flexible body 216 is not provided, the midpoint Q roughly coincides with the center of the accommodating cavity 211 and the center of the housing 210, and thus the midpoint Q may be regarded as being located on the second reference plane or having a smaller distance from the second reference plane. When the flexible body 216 is covered on the outer wall of the second rigid shell 215, the center of the housing 210 changes, so the midpoint Q deviates from the center of the housing 210, and the midpoint Q is located outside the second reference plane.

The above two embodiments illustrate the variation of the position of the midpoint Q of the line connecting the center of the first diaphragm 221 and the center of the second diaphragm 231, with reference to the second rigid shell 215 and the flexible body 216, respectively. It is shown that the ear-clip earphone 200 provided in some embodiments of the present specification are capable of improving the efficiency of utilizing the internal space of the housing 210 by rationally laying out the components within the housing 210 of the sound production portion 21 while ensuring the wearing comfort.

Combined with FIG. 5 and FIG. 19, in some embodiments, a projection of the midpoint Q of the line connecting the center of the first diaphragm 221 and the center of the second diaphragm 231 on the first symmetry plane A1 is the first projection point P1, and an intersection line between the first reference plane A6 and the first symmetry plane A1 is a first intersection line, and a distance between the first projection point P1 and the first intersection line is in the range of 0.4 mm-4 mm.

In some embodiments, a projection of the inner wall of the accommodating cavity 211 on the first symmetry plane A1 is a first projection, a projection of the first reference plane A6 on the first symmetry plane A1 is a second projection. The first projection and the second projection has a first intersection point P2 and a second intersection point P3, and a distance between the first intersection point P2 and the second intersection point P3 is an intersection distance. The first projection includes a first arc segment R1 and a second arc segment R2, and a ratio of the first arc segment R1 to the intersection distance and a ratio of d the second arc segment R2 to the intersection distance are in a range of 1.4-1.7. Because the ratio of the first arc segment R1 to the intersection distance and the ratio of d the second arc segment R2 to the intersection distance are in the range of 1.4-1.7, the first arc segment R1 and the second arc segment R2 are both approximate semicircles, i.e., the projection of the accommodating cavity 211 on the first symmetry plane A1 is closer to a sphere, so that the overall shape of the sound production portion 21 is a sphere or an approximate sphere, making the sound production portion 21 more adapted to the concha cavity, thereby improving the wearing comfort of the ear-clip earphone 200.

In some embodiments, the sound outlet hole 240 may be disposed on the first rigid shell 214. In some embodiments, the sound outlet hole 240 may be disposed on the second rigid shell 215 and the flexible body 216. In some embodiments, the sound outlet hole 240 may be disposed on the first rigid shell 214, the second rigid shell 215, and the flexible body 216.

Merely by way of example, in combination with FIG. 2 to FIG. 3, the sound outlet hole 240 is disposed on the second rigid shell 215 and the flexible body 216. In this way, on the one hand, the sound outlet hole 240 does not need to pass through the first rigid shell 214 and the second rigid shell 215 at the same time, which can avoid the surface of the sound outlet hole 240 being uneven, thereby affecting the installation of the housing 210. On the other hand, the sound outlet hole 240 may be closer to the ear canal when wearing the ear-clip earphone 200, which can effectively improve the quality of the sound emission.

As another example, the sound outlet hole 240 may be disposed in the first rigid shell 214. In this way, the sound outlet hole 240 does not need to pass through both the first rigid shell 214 and the second rigid shell 215, which avoids an uneven surface of the sound outlet hole 240, thereby affecting the installation of the housing 210. In addition, the sound outlet hole 240 is provided in the first rigid shell 214 to avoid opening holes in the flexible body 216, and the influence of the flexible body 216 on the sound outlet hole 240 does not need to be taken into account, which can reduce design and production costs.

The basic concepts have been described above, and it is apparent to those skilled in the art that the foregoing detailed disclosure serves only as an example and does not constitute a limitation of the present disclosure. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

1. An ear-clip earphone comprising:
a sound production portion, configured to be inserted into a concha cavity of a wearer when the ear-clip earphone is worn by the wearer, the sound production portion comprising:
a housing having an accommodating cavity;
a first acoustic driver and a second acoustic driver disposed in the accommodating cavity, a first sound transmission channel being formed between a first diaphragm of the first acoustic driver and a second diaphragm of the second acoustic driver;
a sound outlet hole disposed in the housing, the sound outlet hole being acoustically connected to the first sound transmission channel and exporting sound generated by the first acoustic driver and the second acoustic driver;
an abutting portion, configured to abut against behind the ear of the wearer when the ear-clip earphone is worn; and
an ear hook, configured to bypass an antihelix and a helix of the wearer and connect the sound production portion to the abutting portion when the ear-clip earphone is worn.

2. The ear-clip earphone of claim 1, wherein the ear hook has a first symmetry plane the first symmetry plane passes through the sound outlet hole.

3. (canceled)

4. The ear-clip earphone of claim 1, wherein the ear hook has a first symmetry plane, the first diaphragm and the second diaphragm are symmetrical with respect to a second symmetry plane, and the first symmetry plane and the second symmetry plane form an inclination angle of less than 45 degrees.

5. The ear-clip earphone of claim 1, wherein the ear hook has a first symmetry plane and the sound outlet hole is symmetrical with respect to a third symmetry plane, the third symmetry plane is perpendicular to an inner wall of the concha cavity, and the first symmetry plane and the third symmetry plane form an inclination angle of less than 45 degrees.

6. The ear-clip earphone of claim 4, wherein the sound outlet hole is located entirely on a side of the first symmetry plane closer to an earlobe of the wearer when the ear-clip earphone is worn by the wearer.

7. The ear-clip earphone of claim 1, wherein the ear hook has a first symmetry plane, the first diaphragm and the second diaphragm are symmetrical with respect to a fourth symmetry plane, and the fourth symmetry plane is perpendicular to the first symmetry plane.

8. The ear-clip earphone of claim 7, wherein the sound outlet hole is located entirely on a side of the first symmetry plane closer to an earlobe of the wearer when the ear-clip earphone is worn by the wearer.

9. The ear-clip earphone of claim 7, wherein
a central axis of the sound outlet hole coincides with a central axis of the first sound transmission channel;
a shape of a cross-section of the sound outlet hole perpendicular to the central axis of the sound outlet hole is the same as a shape of a cross-section of the first sound transmission channel perpendicular to the central axis of the first sound transmission channel; and
an entrance of the sound outlet hole is aligned with an opening of the first sound transmission channel.

10. (canceled)

11. The ear-clip earphone of claim 1, wherein
the first acoustic driver comprises a first magnet and a first magnetic conductive shield disposed sequentially away from the first diaphragm, and a first frame for supporting the first diaphragm, the first magnet and the first magnetic conductive shield; and
the second acoustic driver comprises a second magnet and a second magnetic conductive shield disposed sequentially away from the second diaphragm, and a second frame for supporting the second diaphragm, the second magnet and the second magnetic conductive shield.

12. The ear-clip earphone of claim 11, wherein
a second sound transmission channel is formed between the first frame and the second frame,
the first frame comprises a plurality of first air transmission holes, the second frame comprises a plurality of second air transmission holes,
a side of the first diaphragm away from the first sound transmission channel is connected to the second sound transmission channel through the plurality of first air transmission holes, and
a side of the second diaphragm away from the first sound transmission channel is connected to the second sound transmission channel through the plurality of second air transmission holes.

13. The ear-clip earphone of claim 11, wherein the sound production portion further comprises a mounting bracket, and the first acoustic driver and the second acoustic driver are mounted jointly on the mounting bracket;
the mounting bracket is provided with a protrusion at a position corresponding to the sound outlet hole, and the protrusion abuts against an inner wall of the housing.

14. (canceled)

15. The ear-clip earphone of claim 13, wherein the protrusion is provided with a through-hole, a first cross-section of the through-hole is flush with an end surface of the first frame, and a second cross-section of the through-hole is flush with an end surface of the second frame.

16. The ear-clip earphone of claim 13, wherein
the mounting bracket comprises the protrusion and an annular notch portion connected to the protrusion,
the annular notch portion has only one positioning structure,
the positioning structure is configured to locate the first frame and the second frame with the mounting bracket, and
the positioning structure is a combination of a positioning protrusion and a positioning groove.

17. The ear-clip earphone of claim 13, wherein
a maximum distance in an axial direction of a structure formed by the first acoustic driver, the second acoustic driver and the mounting bracket is a first dimension,
a maximum distance in a radial direction of the structure formed by the first acoustic driver, the second acoustic driver and the mounting bracket is a second dimension, and
a ratio of the first dimension to the second dimension is within the range of 0.85 to 1.15.

18. The ear-clip earphone of claim 12, wherein the housing is provided with a pressure relief hole acoustically connected to the second sound transmission channel:
the first frame is provided with a plurality of first bonding pads at an end surface away from the first diaphragm, a minimum distance between at least a portion of the first bonding pads and the pressure relief hole is first minimum distance, a minimum distance between at least a portion of the air transmission holes and the pressure relief hole is a second minimum distance, and the first minimum distance is greater than the second minimum distance; and
the second frame is provided with a plurality of second bonding pads on an end surface away from the second diaphragm, a minimum distance between at least a portion of the second bonding pads and the pressure relief hole is a third minimum distance, and a maximum minimum distance between at least a portion of the second air transmission holes and the pressure relief hole is a fourth minimum distance, and the third minimum distance is greater than the fourth minimum distance.

19-25. (canceled)

26. The ear-clip earphone of claim 1, wherein a resonance frequency of the first diaphragm and a resonance frequency of the second diaphragm are both less than 300 Hz, and a difference between the resonance frequency of the first diaphragm and the resonance frequency of the second diaphragm is less than 50 Hz.

27. (canceled)

28. The ear-clip earphone of claim 1, wherein the housing comprises:
a first rigid shell;
a second rigid shell, configured to be disposed toward the concha cavity of the wearer when the ear-clip earphone is worn; and
a flexible body, configured to be in contact with the concha cavity of the wearer when the ear-clip earphone is worn;
wherein the first rigid shell and the second rigid shell enclose to form the accommodating cavity, and the flexible body covers an outer wall of the second rigid shell.

29. The ear-clip earphone of claim 28, wherein
a plane in which the outermost annulus of an end surface of the flexible body is located is a first reference plane, and the midpoint of a line connecting the center of the first diaphragm and the center of the second diaphragm is located outside the first reference plane; or
a plane in which the outermost annulus of an end surface of the second rigid shell is located is a second reference plane, and the midpoint of the line connecting the center of the first diaphragm and the center of the second diaphragm is located outside the second reference plane.

30. The ear-clip earphone of claim 29, wherein
the ear hook has a first symmetry plane,
a projection of the midpoint of the line connecting the center of the first diaphragm and the center of the second diaphragm on the first symmetry plane is a first projection point,
an intersection line between the first reference plane and the first symmetry plane is a first intersection line, and
a distance between the first projection point and the first intersection line is in the range of 0.4 mm˜4 mm.

31. (canceled)

32. The ear-clip earphone of claim 29, wherein
a projection of an inner wall of the accommodating cavity on the first symmetry plane is a first projection, a projection of the first reference plane on the first symmetry plane is a second projection, the first projection and the second projection have a first intersection and a second intersection, and a distance between the first intersection and the second intersection is an intersection distance; and
the first projection comprises a first arc segment and a second arc segment, and a ratio of the first arc segment to the intersection distance and a ratio of the second arc segment to the intersection distance are in a range of 1.4 to 1.7.

33. (canceled)
